(19) United States
(12) Patent Application Publication
(10) Pub. No.: US 2026/0226779 A1
(43) Pub. Date: Aug. 6, 2026

(54) REINFORCED SLIDING PANEL STRUCTURE

(71) Applicant: PANORAMIC DOORS, LLC, Fort Worth, TX (US)

(72) Inventors: Brett CHAMBERLIN, Plano, TX (US); Michael James REES, Euless, TX (US)

(21) Appl. No.: 19/153,304

(22) PCT Filed: Jan. 31, 2024
(86) PCT No.: PCT/US2024/013899

§ 371 Date: Aug. 1, 2025

Related U.S. Application Data
(60) Provisional application No. 63/482,667, filed on Feb. 1, 2023.

(51) Int. Cl. E05D 15/58; E06B 3/50

(52) U.S. Cl. CPC E05D 15/581; E06B 3/5072; E06B 3/509; E05D 2015/586; E05Y 2900/132

(57) ABSTRACT

A frame has an upper support track and a lower guide rail and supports a first panel with a groove member and a sliding second panel. The second panel includes a tongue member to mate with the groove member, the tongue member disposed on a vertical edge of the second panel. The second panel includes a flange element disposed on the vertical edge to overlap a portion of the first panel when the tongue member is inserted into the groove member. A mutual attraction device is provided including a first mutual attraction part and a second mutual attraction part connected to the second panel. A fulcrum tilts the second panel when the first mutual attraction part engages the second mutual attraction part, the tilting allowing for the extension to disengage the lower guide rail to allow the second sliding panel to pivot about the sliding panel pivot axis.

### RELATED APPLICATION

This application claims benefit to U.S. Provisional Patent Application Ser. No. 63/482,667, filed Feb. 1, 2023, the disclosure of which is incorporated by reference herein in its entirety.

### TECHNICAL FIELD

The present invention relates to door panel structures, and in particular, to door panel structures having sliding doors and pivoting doors.

### BACKGROUND

Various types of track-suspended door structures are known. For example, U.S. Pat. No. 3,266,189 shows a typical power-operated arrangement. It is known to so arrange sliding doors that the doors can move not only in direction of a suspension track, for example in a straight line to and from each other, but additionally include panel members which are arranged for swinging movement transverse to the direction of sliding movement. Such additional swinging movement is desirable particularly in installations where a maximum panel opening is desired, for example to permit a large number of people to rapidly leave a building, or to provide an opening of increased width for vehicular traffic. Residential applications whereby the user desires maximum view and ventilation are also to be appreciated. However, sliding doors which are so arranged cause difficulties since swinging movement of the door panels or door elements of sliding doors does not permit attaching of hinges about which the doors can swing to a fixed frame. The attachment point for the hinges are movable and for swinging movement the doors can no longer be supported along their width from the top. For example, the hinge attachment on a sliding door panel will shift, causing the door, as it swings, to bind against a floor structure. It is customary to provide sliding doors with a downwardly projecting guide element, typically a bolt, or the like, which slides in a guide track or rail. This bolt, however, is movable longitudinally in a sliding direction and will shift its position upon release of a swinging door element from the sliding door structure, so that it is suspended only on the hinges, due to the force moment which the door exerts on the hinge structure. It is undesirable to foreshorten the door so that the tilting of the door frame, upon swinging movement of the door, is compensated, since, then, when the door is closed, a gap will permit exchange of heated or cooled air, and otherwise interfere with the purposes of a door, which is to close off an opening.

U.S. Pat. No. 4,438,594 uses a massive metal angle element to provide a pre-stressing force and keep the door panel from binding with the floor structure art to counteract the weight as the panels swing open. This type of counterweight would add considerably to the weight of the door and require more strength to push the panel open or closed. Massive counterweights require reinforcements in the building frame and door jamb to hold the additional weight. A massive counterweight would require heavy duty bogies, guide tracks, and pivot hinges to carry the weight. Shipping would also be more expensive due to the additional weight. Installation of the door panels would require more manpower to hold up the “massive counterweight” while installers secure the panels to the bogies. The added shipping weight, manufacturing cost and labor would be cost prohibitive.

U.S. Pat. No. 5,272,839 uses a toothed apparatus and hinge pins to eliminate friction and weight transfer. The '839 patent also suggests a wing shaped bracket to prevent the pane from tilting. Brackets springs, and toothed apparatus require precision manufacturing and highly trained installers because the panels would need to be aligned perfectly. Toothed apparatuses and wing shaped brackets can wear out easily with repeated use. These disadvantages would add to the cost of manufacturing and installation as well as allowing for more points of failure in the closure.

Bi-folds closure, which are known and have been around since the 1950's. The Nana bi-fold doors manufactured by Nana Wall Systems, Inc. or the lanai bi-fold doors, manufactured by Lanai Doors Incorporated, require four to eight hinge mechanisms per panel to stabilize and transfer the weight of the attached open panels to the frame of the building. These many hinges keep the panels from binding against a floor structure. These hinge mechanisms require precise manufacturing and installation because many of the panels are attached together like a train and a failure at one hinge or wheeled carriage bogie effects all the attached panels rendering the door inoperable.

With many parts that need to be manufactured and assembled precisely and difficult installation, the costs for these bi-fold closure systems tend to be in the high end or Luxury category. More hinges also create more failure points for these bi-fold closures. Bi-fold closures are limited in their width due to the fact that the more panels that are attached together, the heavier the closure becomes and the harder it is for the consumer to push open a multi panel bi-fold closure because they need to move all the attached weight.

### BRIEF DESCRIPTION OF THE DRAWINGS

FIGS. 1-1E show a preferred embodiment. FIGS. 2A-2B show the stationary door opened.

FIGS. 2C-2G show the sliding door moving towards the stationary door. FIG. 2H shows the operation of the fulcrum.

FIGS. 3A-3B show the first sliding door opened.

FIGS. 3C-3E show the second sliding door moving towards the first sliding door.

FIG. 3F shows the operation of the fulcrum on the second sliding door.

FIGS. 3G-3H show the second sliding door opened.

FIG. 4 shows another preferred embodiment.

FIGS. 5-6 show another preferred embodiment.

FIGS. 7-9H show another preferred embodiment.

FIG. 10 shows a sliding door structure with a stationary panel and a plurality of sliding panels.

FIGS. 11A-11B are images showing a cross-section of panel frames implementing a press-fit tongue and groove connection.

FIGS. 12A-12B are diagrams showing cross-sections of panel frames implementing press-fit tongue and groove connections.

FIG. 13 is an image showing reinforcement of an example sliding panel.

FIGS. 14A-14C are views of an example sliding panel with a throw bolt.

### DESCRIPTION OF EXAMPLE EMBODIMENTS

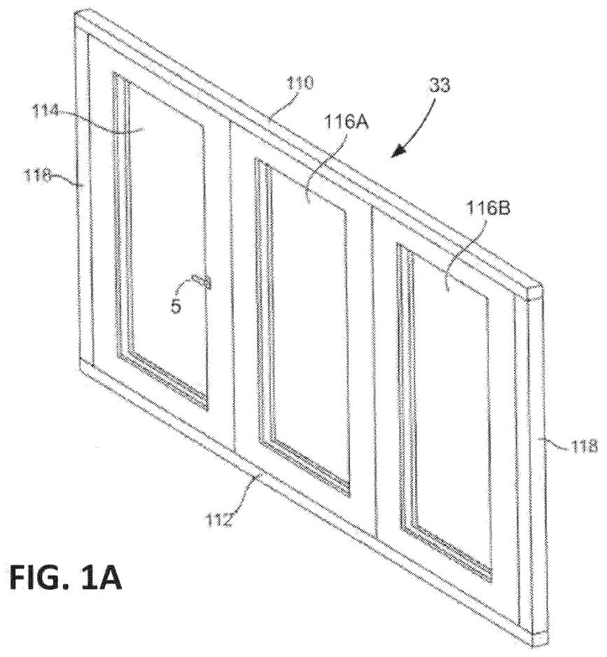

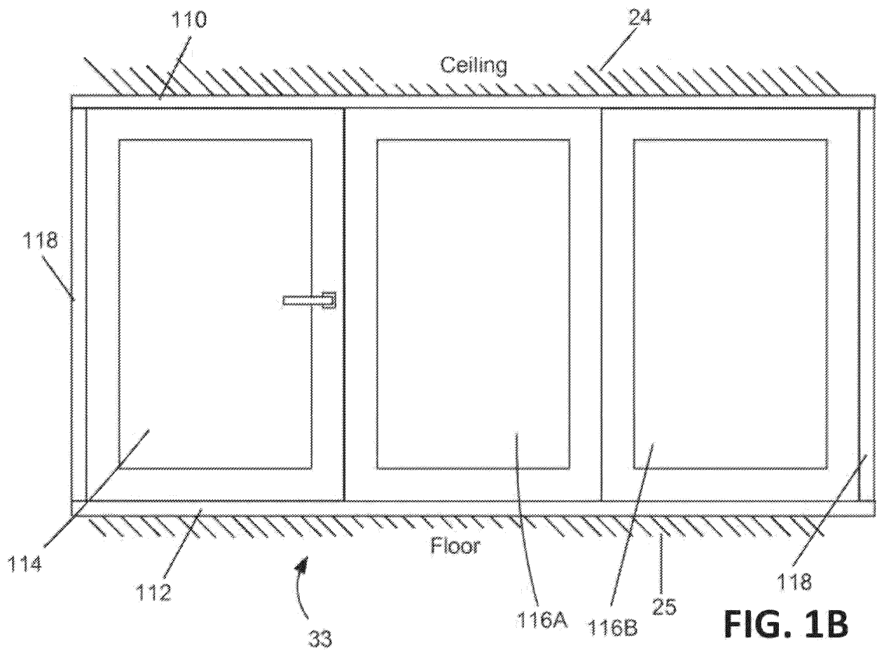

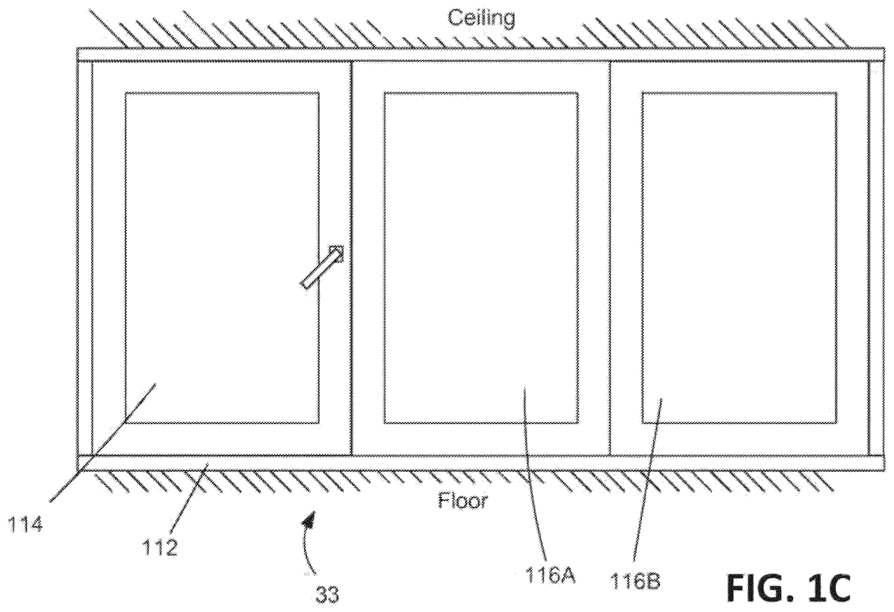

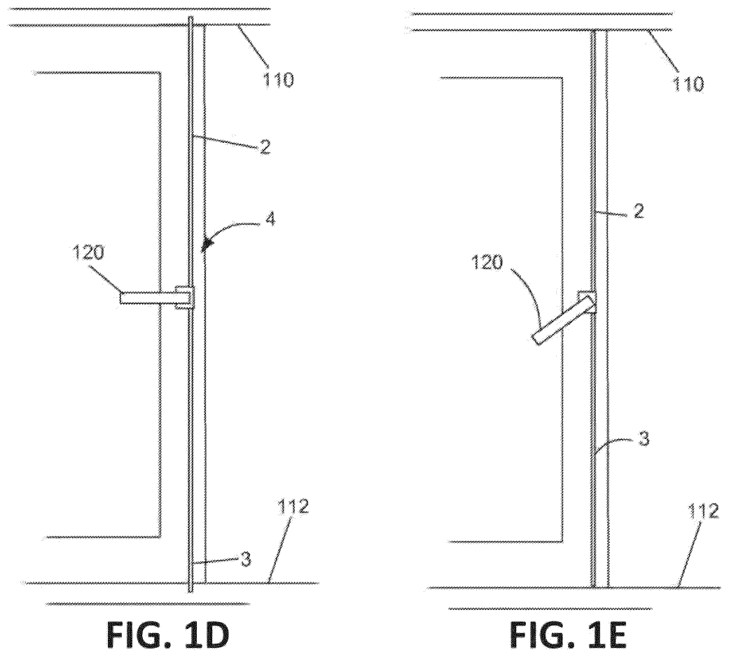

FIG. 1A shows a right perspective view and FIG. 1B shows front view ofa sliding door structure 33. Sliding door structure 33 is shown in the closed position and includes an upper support track 110 and a lower guide rail 112. In a preferred embodiment both upper support track 110 and lower guide rail 112 are aluminum extrusions. Upper support track 110 is preferably fastened to ceiling 24 and a lower guide rail 112 is preferably attached to floor 25. Door jambs 118 are located as shown on both sides of sliding door structure 33 to form a door frame with the upper support track 110 and lower guide rail 112 sections. In one example, the sliding door structure 33 includes one stationary door 114 and one or more sliding doors (e.g., 116A and 116B). The panel frames of doors 114, 116B and 116A are preferably constructed of aluminum extrusions. Also, preferably, panels of the doors 114, 116A, 116B include an insulated glazing unit (not shown).

As shown in FIG. 1D, sliding door structure 33 preferably utilizes dual point shoot bolt locking hardware 4. More particularly, the stationary door 114 is secured in the position shown in FIGS. 1A and 1B by the extension of shoot bolt 2 into upper support track 110 and the extension of shoot bolt 3 into lower guide rail 112. As the user turns handle 120 forty-five degrees (e.g., as in FIGS. 1C and 1E), shoot bolts 2 and 3 are retracted. This disengages door 114 from upper support track 110 and lower guide rail 112 so that the door can be easily opened.

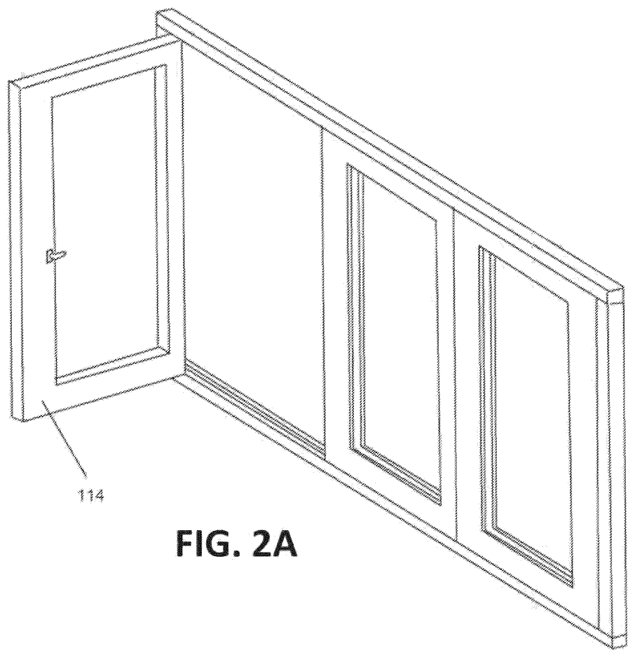

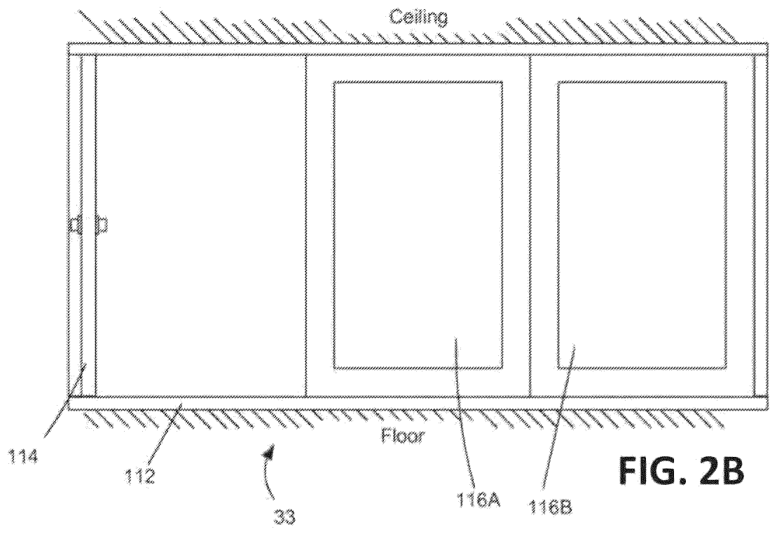

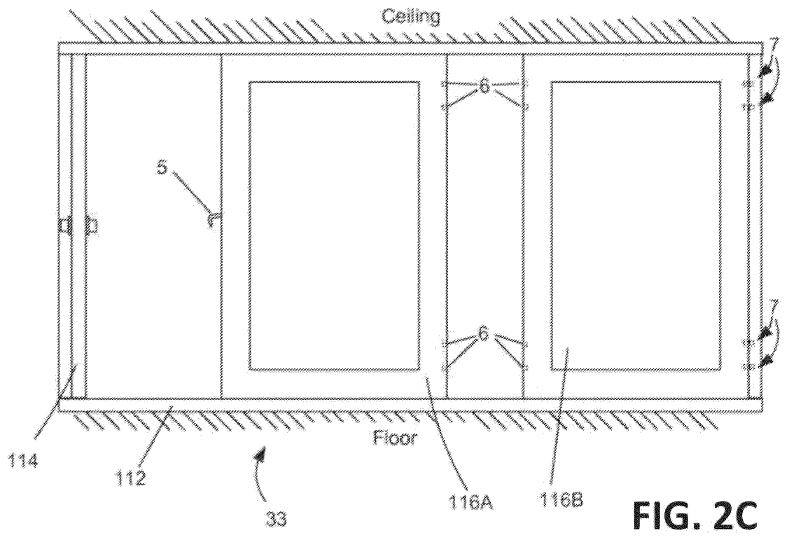

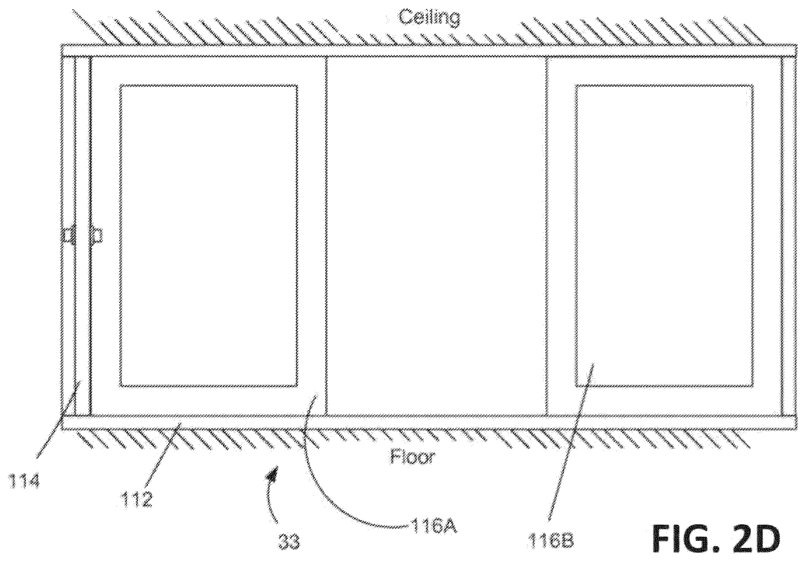

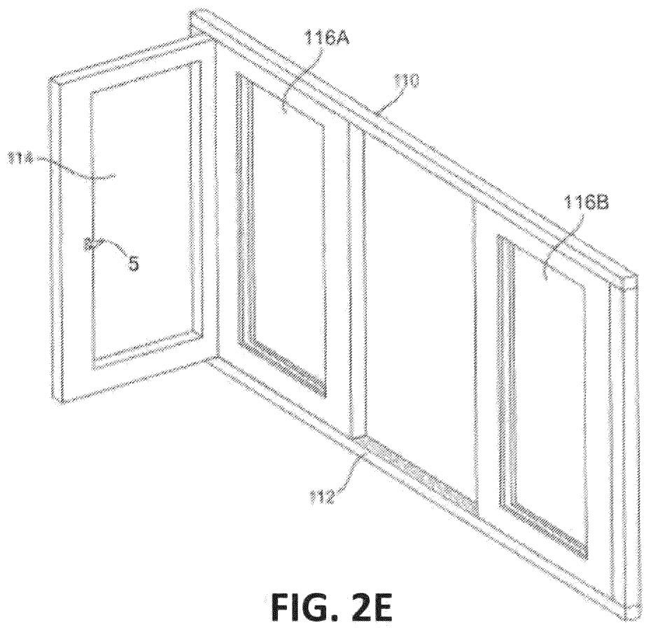

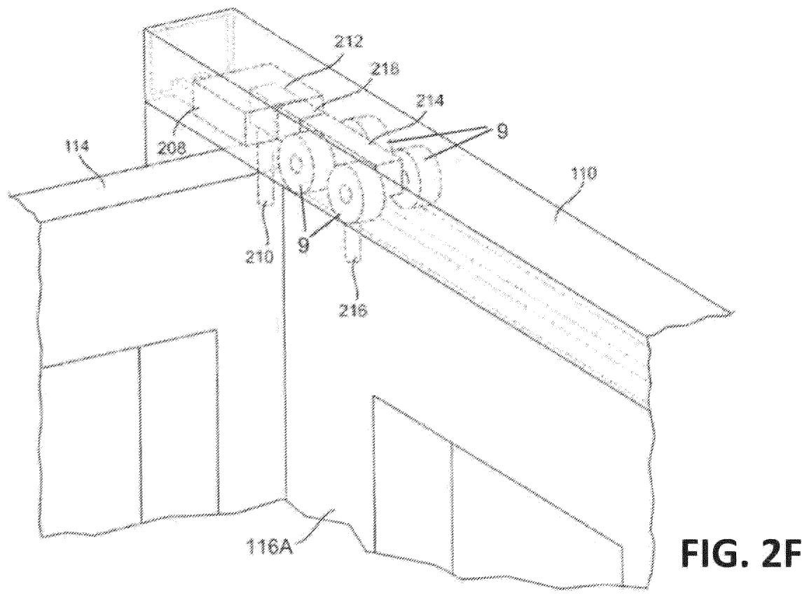

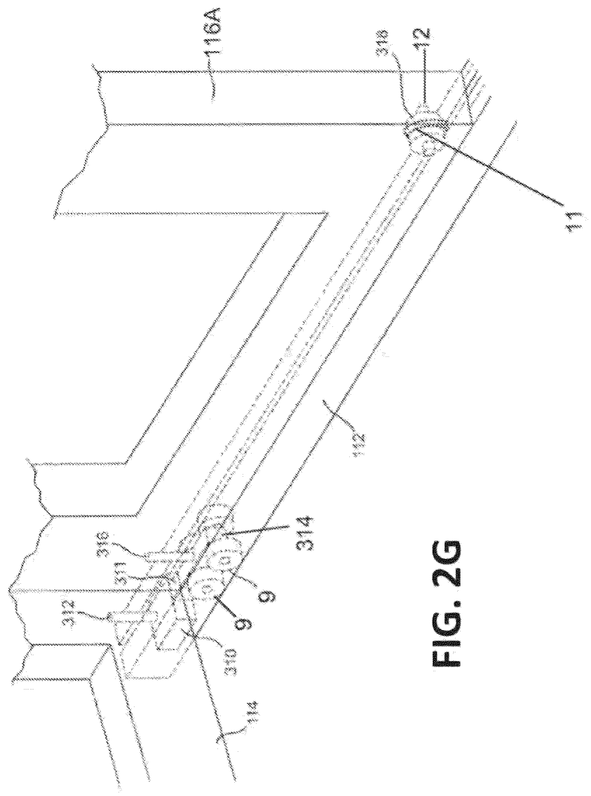

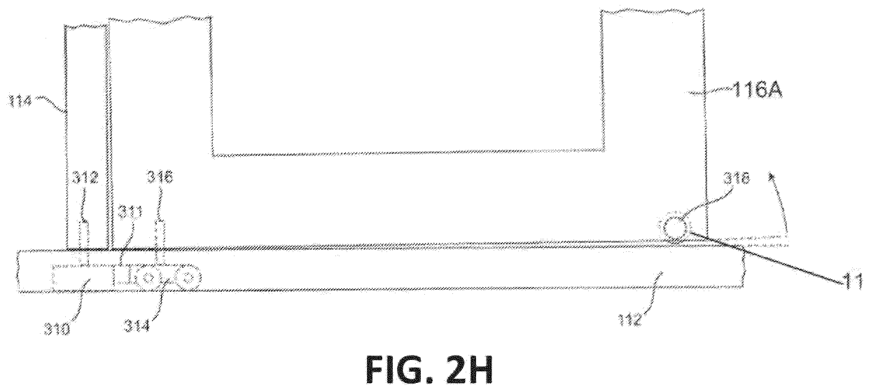

As illustrated in FIGS. 2A and 2B the stationary door 114 is shown in an opened position (e.g., after a user has pulled stationary door 114 so that it has pivoted 90 degrees and is opened). With the stationary door 114 opened, a user may slide the sliding doors (e.g., 116A, 116B) into the space created by the opening of the stationary door 114. For instance, as shown in FIG. 2C, a user has grabbed retractable handle 5 and has pulled sliding door 116A to the left with sufficient force to overcome a magnetic attraction of door magnets 6 provided on the edges of sliding doors 116A and 116B. In a preferred embodiment, the magnetic attraction force between magnets 7 is greater than the magnetic attraction force between magnets 6. Therefore, as the user pulls handle 5, door 116A moves leftward but door 116B remains in place.

As further shown in FIGS. 2D, 2E, and 2F, the user has pulled sliding door 116A all the way leftward. FIG. 2F shows a close up perspective view of the tops of stationary door 114, sliding door 116A, and upper support track 110 (e.g., after the stationary door 114 has been opened and the sliding door 116A is slid to the opening created by the opened stationary door 114 (e.g., as in FIGS. 2D and 2E)). As further shown in FIG. 2F, upper pivot hinge 210 extends downward from stationary upper anchor 208. Stationary door magnet 212 is housed inside stationary upper anchor 208. Likewise, upper pivot hinge 216 (of sliding door 116A) extends downward into the sliding door 116A from upper bogie 214. Sliding door magnet 218 is attached to upper bogie 214. Upper bogie 214 is supported by wheels 9. Wheels 9 are configured to roll inside upper support track 110, thereby allowing sliding door 116A to slide leftward and rightward.

As shown in FIG. 2F stationary door 114 is pivoted 90 degrees open and sliding door 116A has been slid toward stationary door 114 so as to engage stationary door magnet 212 with sliding door magnet 218. Preferably magnets of an industrial strength and quality are utilized. In one example, such as shown in FIG. 2F, upper support track 110 is formed to have the approximate shape of an upside down “u” with flanges pointing inward toward the center and a groove running down the middle so that bogie 214 can run horizontally within upper support track 110. Stationary door 114 is attached to stationary upper anchor 208 via a fixed pivot hinge 210 (which does not slide). Preferably, stationary upper anchor 208 is fabricated from aluminum.

FIG. 2G shows a close up perspective view of the bottom of stationary door 114, sliding door 116A, and lower guide rail 112. As shown in FIG. 2G, lower pivot hinge 312 extends upward from bottom stationary anchor 310 into the bottom of the stationary door 114. Likewise, lower pivot hinge 316 extends upward from lower bogie 314 into the bottom of the sliding door 116A. Lower bogie 314 is supported by wheels 9. Wheels 9 are configured to roll inside lower guide rail 112, thereby allowing sliding door 116A to slide leftward and rightward. In one example, lower guide rail 112 has a cross section that is fabricated in the general shape of a “u” with flanges pointing inward toward the center and a groove running down the middle so lower pivot hinge 316 can run horizontally within the lower guide rail 112. Lower bogie 314 is constructed similar to upper bogie 214.

In one example, roller 318 is attached to sliding door 116A via axis 12. Roller 318 includes center extension 11 that fits into groove 13 of lower guide rail 112. Other implementations of the lower guide rail 112 may adopt other (e.g., non-Li-shaped) geometries and corresponding roller geometries may be utilized to allow sliding doors to securely roll, or slide, using the lower guide rail. In one example, roller 318 is wider than the groove 13 and rides on the top of lower guide rail 112.

Preferably, roller 318 is made from a heavy duty convex nylon. Roller 318 is attached to sliding door 116A in such a way as to enable sliding door 116A to be slid horizontally left or right while keeping sliding door 116A square in the closure. Center extension 11 holds sliding door 116A parallel to upper support track 110 and lower guide rail 112 while sliding door 116A is being slid leftward or rightward.

### Fulcrum

As shown in FIGS. 2G and 2H, fulcrum 311 is rigidly connected to stationary bottom anchor 310 so as to stop lower bogie 314 just before stationary door magnet 212 and sliding door magnet 218 are drawn together via magnetic force. Fulcrum 311 is installed in such a way as to work in unison with stationary door magnet 212 and sliding door magnet 218 and lower bogie 314 to tilt sliding door 116A so as to lift center extension 11 clear of groove 13 of lower guide track 112 (see also FIG. 2H).

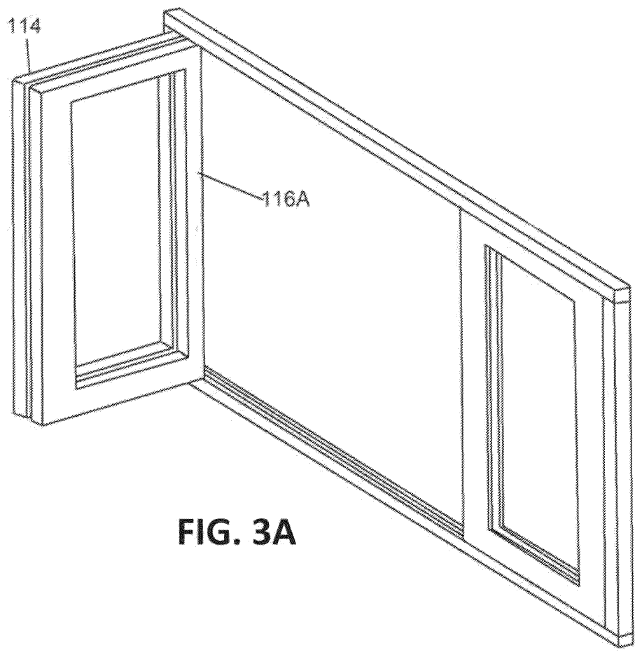

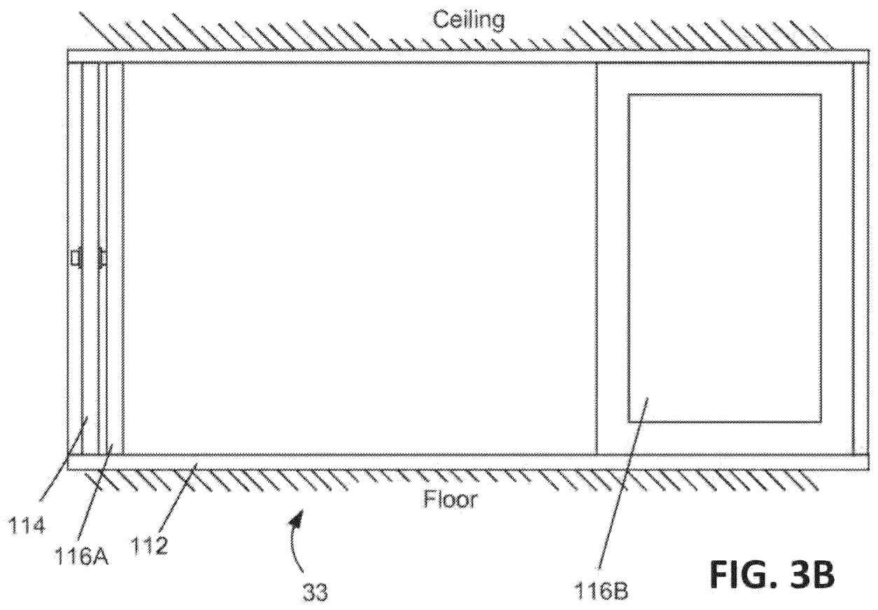

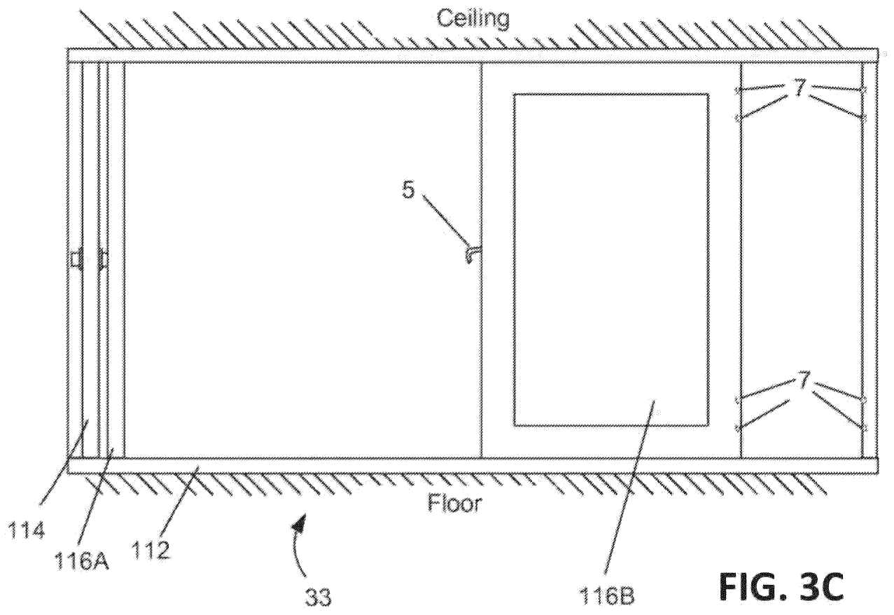

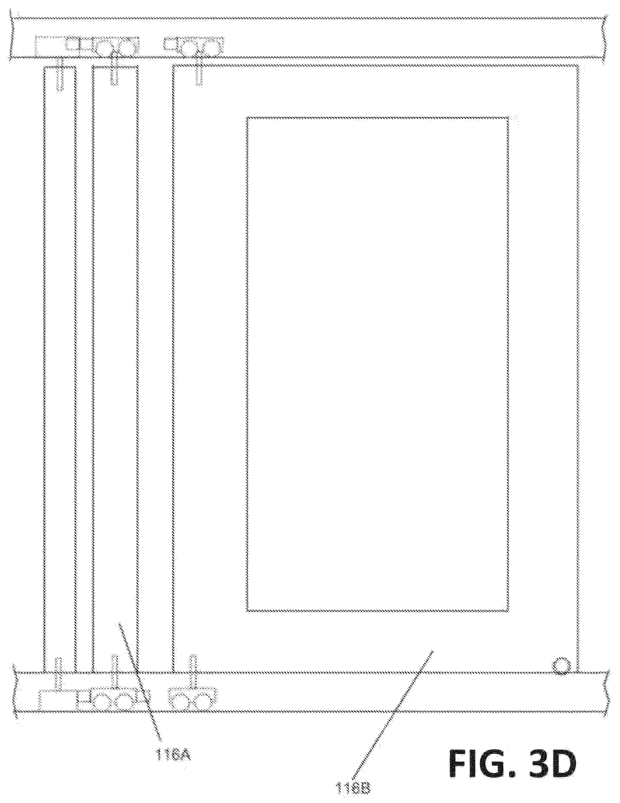

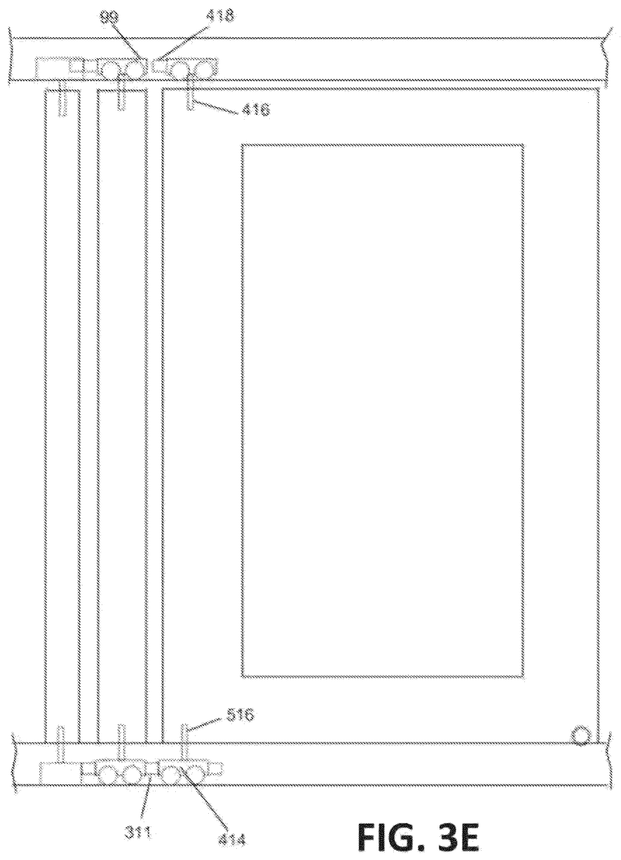

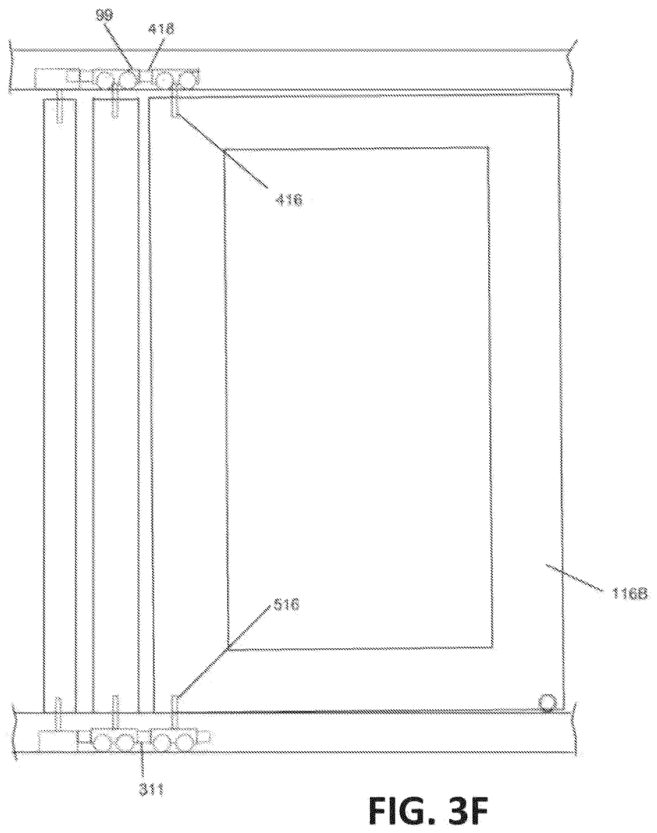

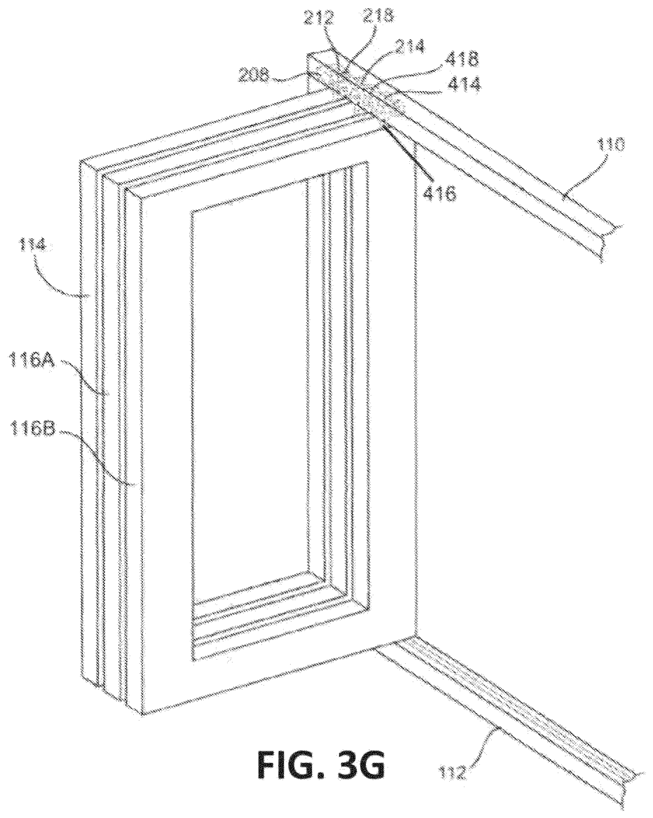

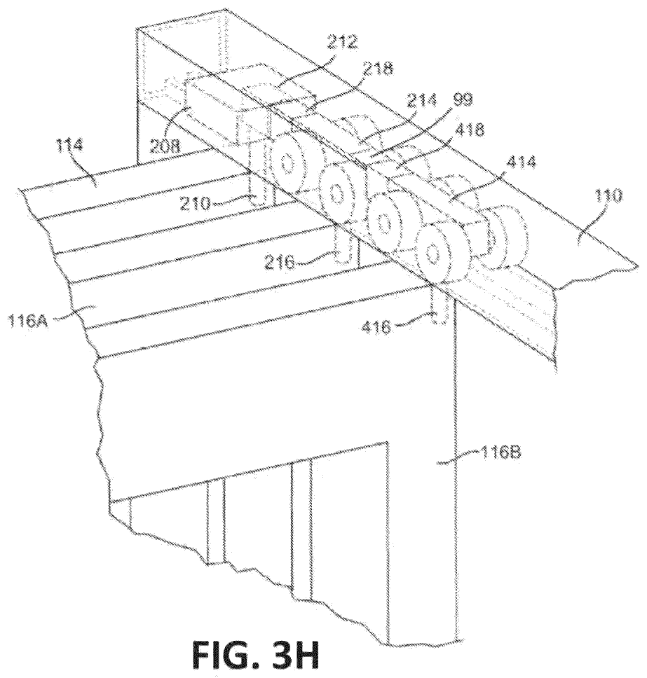

As shown in FIGS. 3A and 3B, because extension 11 is clear of groove 13 (e.g., as shown in FIG. 2H due to engagement with the fulcrum), the user is able to pull on sliding door 116A causing it to pivot about the axis formed by upper pivot hinge 216 and lower pivot hinge 316. In FIG. 3C the user has grabbed retractable handle 5 of sliding door 116B overcoming the magnetic attractive force of magnets 7 to begin moving sliding door 116B within the upper and lower guide tracks toward stationary door 114 and sliding door 116A. In FIG. 3D, the user has pulled sliding door 116B so that it is very close (e.g., nearly adjacent) to opened sliding door 116A. Extension 11 is inside groove 13 (FIG. 2G) of lower guide track 112.

In FIG. 3E, lower bogie 414 of sliding door 116B has made contact with fulcrum 311. Inside upper support track 110 magnet 418 has not made contact with magnet 99. However, the magnets are of sufficient strength and distance so that a magnetic force is drawing them together. As shown in FIG. 3F, magnetic force has drawn magnet 418 and magnet 99 together due to sliding door 116B being brought into close proximity with the opened sliding door 116A. Thus, fulcrum 311 has caused sliding door 116B to pivot as shown so that extension 11 has cleared groove 13 (FIG. 2G) of lower track guide 112. With the extension cleared from the lower track guide, a user may easily open sliding door 116B so that it can pivot about the axis formed by upper pivot hinge 416 and lower pivot hinge 516, as shown in FIGS. 3G and 3H.

### Multiple Sliding Doors

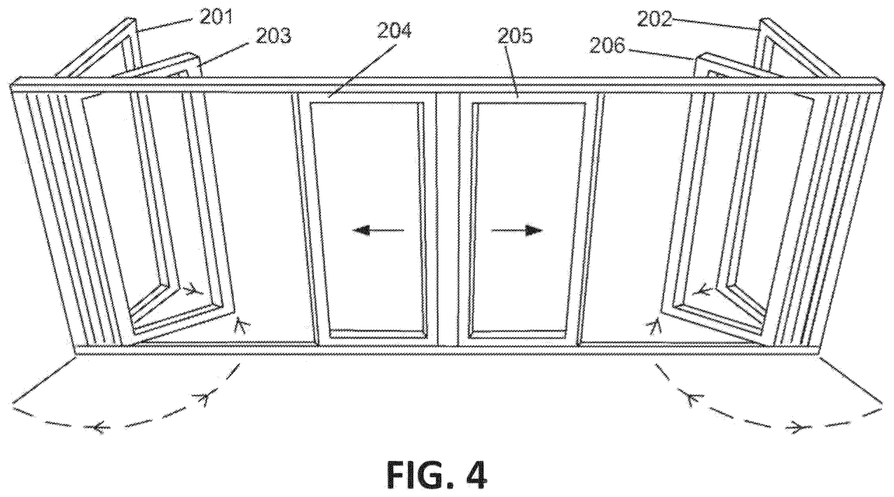

The example sliding door structure discussed in the examples of FIGS. 1A-3H is shown as having one stationary door 114 and two sliding doors 116A and 116B. However, it should be appreciated that it is possible to modify this example such that more than two sliding doors are provided with the stationary door. Further, in some implementations, multiple stationary doors may be provided with corresponding sliding doors. As one illustrative example, FIG. 4 shows sliding door structure 34 having two stationary doors 201 and 202, one at each end of an elongated door frame sized to accommodate the multiple stationary and sliding doors. In this example, sliding door structure 34 also has four sliding doors 203, 204, 205 and 206.

Doors 203 and 204 are configured to slide to the left (toward stationary door 201) and doors 205 and 206 are configured to slide to the right (toward stationary door 202), among other example configurations.

### Windows

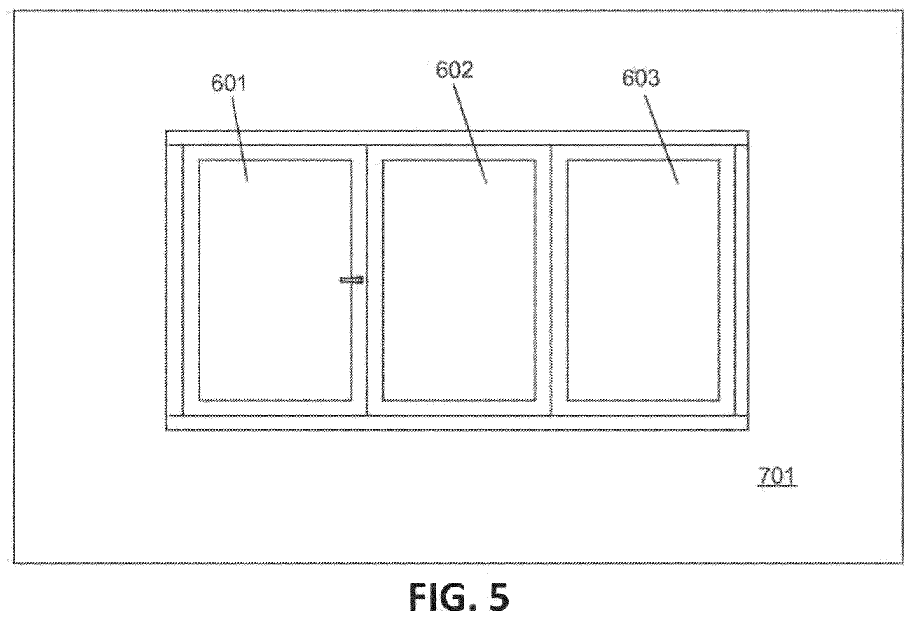

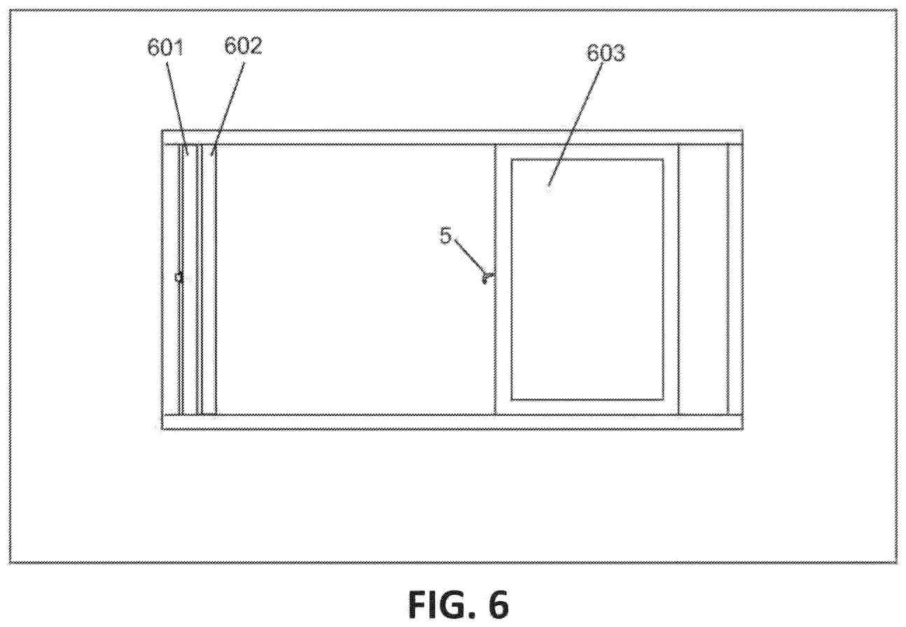

Although the above embodiments describe doors, it is also possible to utilize the solutions presented herein for other panel devices. For example, FIG. 5 shows an implementation for sliding and pivoting window panels. FIG. 5 shows stationary window 601 and sliding windows 602 and 603 mounted onto wall 701.

In FIG. 6, the user has opened stationary window 601 and sliding window 602 in a fashion similar to that described above. The user has grabbed retractable handle 5 and is pulling sliding window 603 leftward. If the user desires, he can also open sliding window 603 by utilization of a fulcrum in a fashion similar to that described above (e.g., in the examples of FIGS. 1A-3H).

### Other Preferred Embodiment

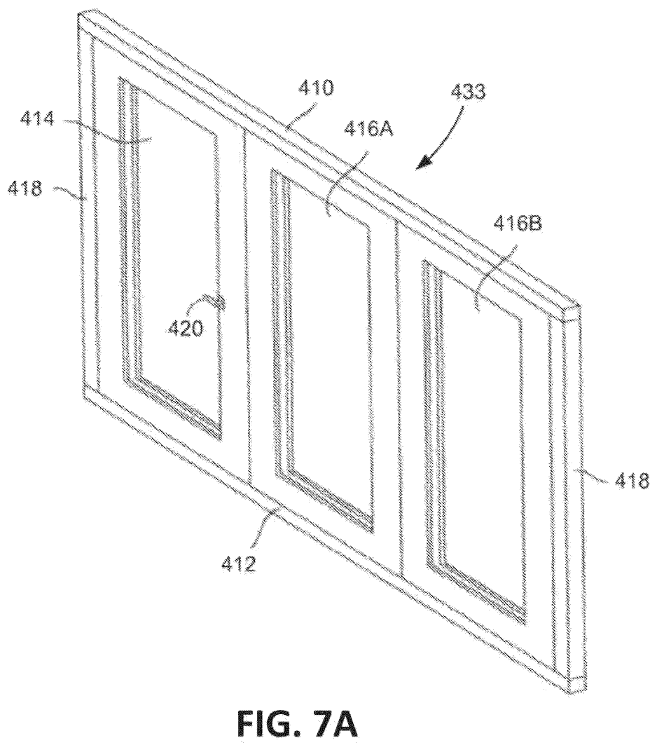

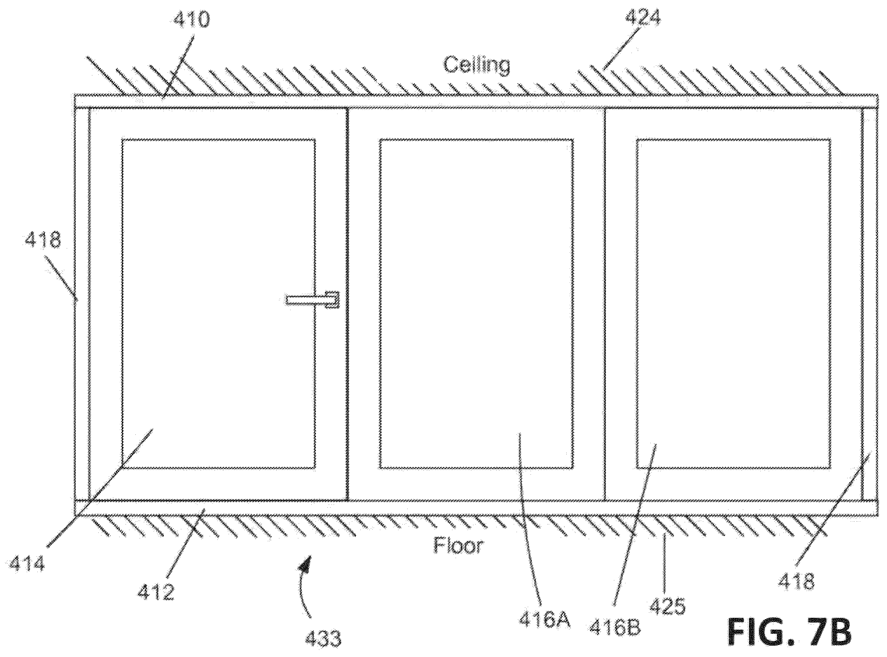

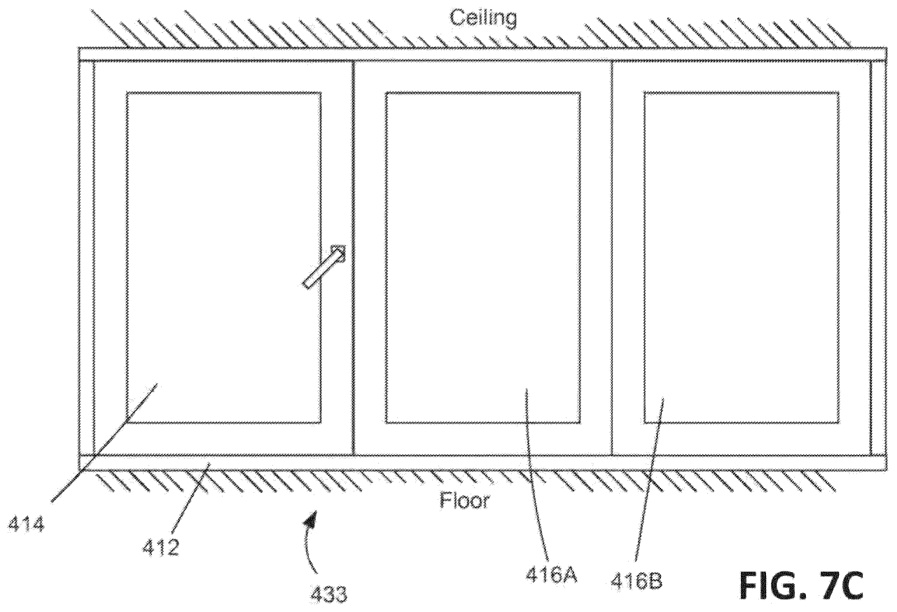

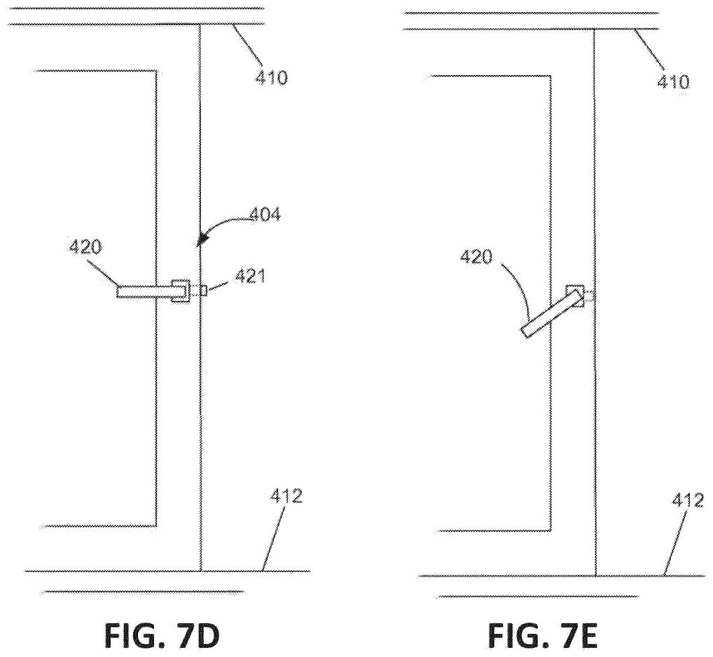

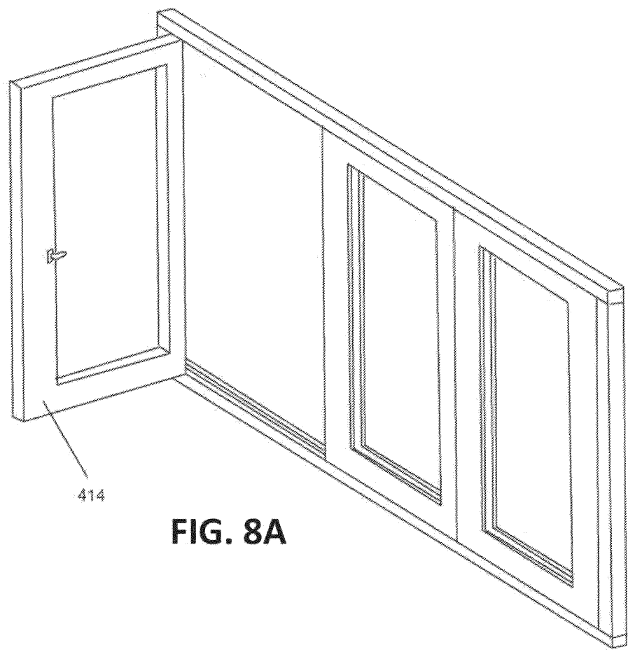

FIG. 7A shows a right perspective view and FIG. 7B shows a front view of sliding door structure 433. Sliding door structure 433 is shown in the closed position and includes upper support track 410 and a lower guide rail 412. In a preferred embodiment both upper support track 410 and lower guide rail 412 are aluminum extrusions. Upper support track 410 is preferably fastened to ceiling 424 and a lower guide rail 412 is preferably attached to floor 425. Door jambs 418 are located as shown on both sides of sliding door structure 433. In this example, sliding door structure 433 includes one stationary door 414 and two sliding doors 416A and 416B, although other example implementations may include additional stationary doors and/or more or fewer stationary doors. In one example, the door panel frames of doors 414, 416B, and 416A are preferably constructed of aluminum extrusions. Also, preferably, doors 414, 416A, and 416B include an insulated glazing unit (not shown).

Sliding door structure 433 preferably utilizes looking door latch 404, such as shown in FIGS. 7D and 7E. the locking door latch 404 may be utilized in addition to or instead of a shoot bolt arrangement (e.g., as shown in FIGS. 1D-1E). For instance, stationary door 414 is secured in the position shown in FIGS. 7A and 7B by the extension of locking bolt 421 into door 416A. As the user turns handle 420 forty-five degrees (as shown in FIGS. 7C and 7E), locking bolt 421 is retracted. This disengages door 414 from door 416A so that door 414 can be easily opened.

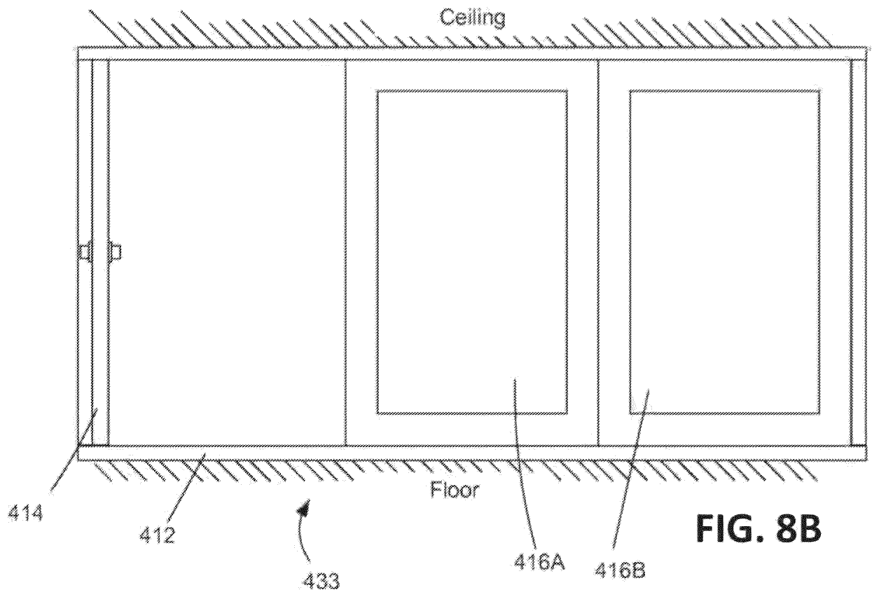

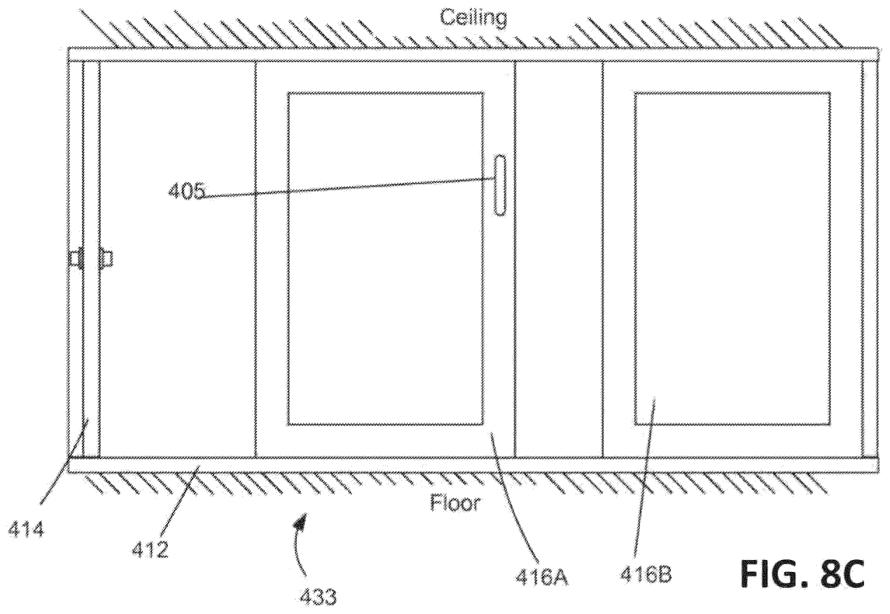

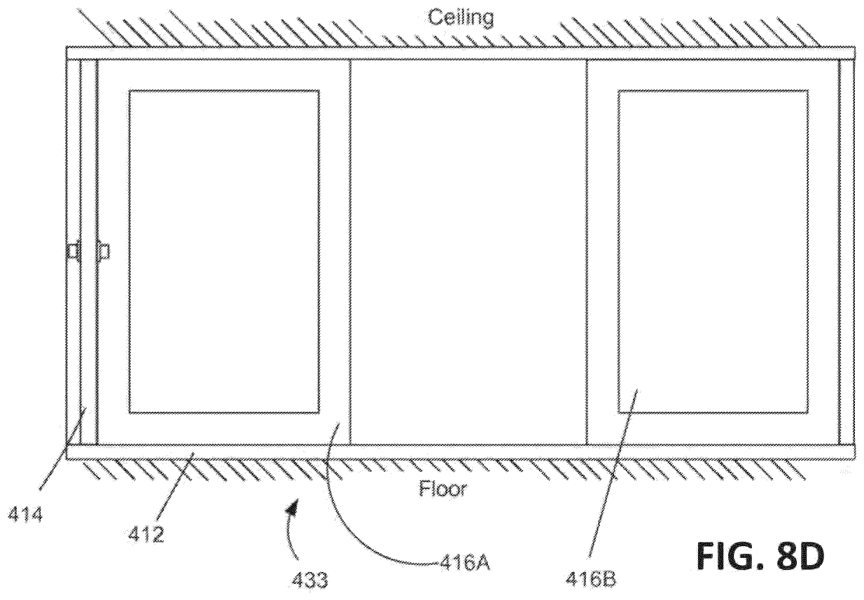

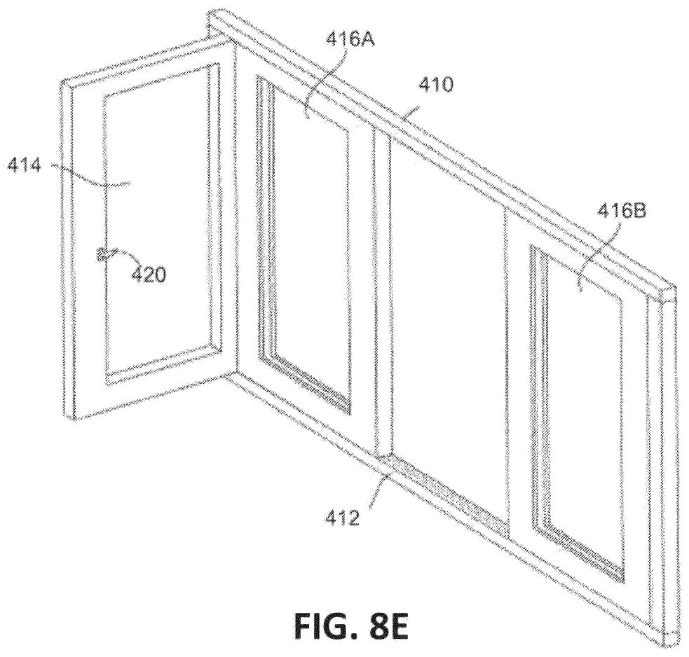

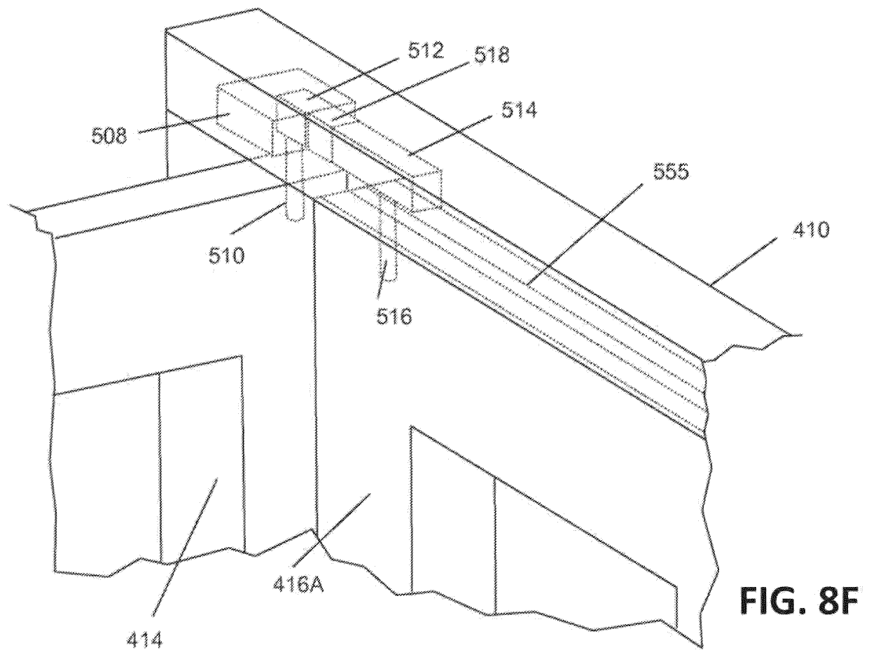

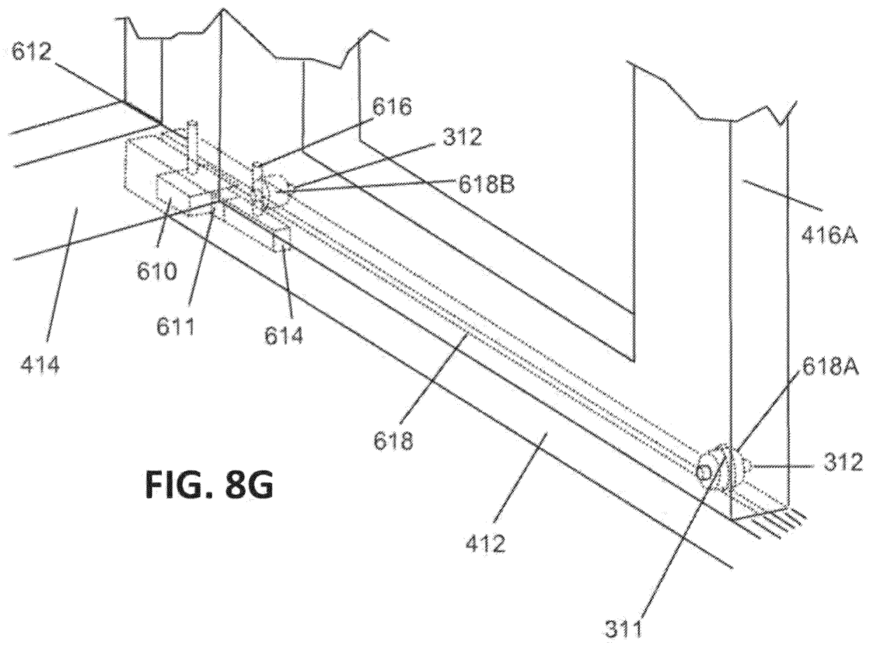

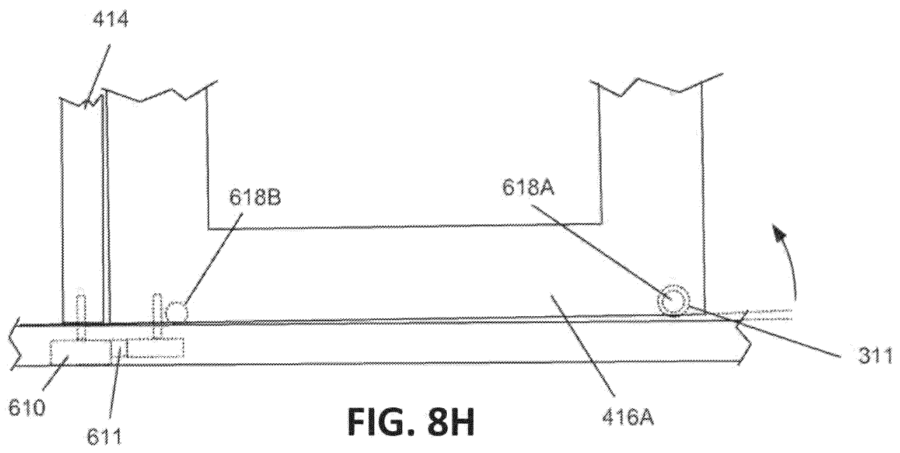

As shown in FIGS. 8A and 8B a user has pulled stationary door 414 so that it has pivoted 90 degrees and is opened. In FIG. 8C the user has grabbed handle 405 and has pulled sliding door 416A to the left. It should be noted that handle 405 is also useful in providing the user with sufficient leverage to overcome the magnetic attraction between magnets 512 and 518 (FIG. 8F) when sliding the doors apart.

As shown in FIGS. 8D, 8E, and 8F the user has pulled sliding door 416A all the way leftward. FIG. 8F shows a close up perspective view of the tops of stationary door 414, sliding door 416A and upper support track 410. As further shown in FIG. 8F, upper pivot hinge 510 extends downward from stationary upper anchor 508. Stationary door magnet 512 is housed inside stationary upper anchor 508. Likewise, upper pivot hinge 516 extends downward from upper magnet holder 514 through slot 555. Sliding door magnet 518 is attached to upper magnet holder 514. As shown in FIG. 8F stationary door 414 is pivoted 90 degrees open and sliding door 416A has been slid toward stationary door 114 so as to engage stationary door magnet 512 with sliding door magnet 518. Preferably magnets of an industrial strength and quality are utilized.

FIG. 8F shows upper support track 410 having the approximate shape of an upside down “u” with flanges pointing inward toward the center and groove 555 running down the middle so that upper magnet holder 514 can run horizontally within upper support track 410. Stationary door 414 is attached to stationary upper anchor 508 via fixed pivot hinge 510. Preferably, stationary upper anchor 508 is preferably fabricated from aluminum. FIG. 8G shows a close up perspective view of the bottom of stationary door 414, sliding door 416A and lower guide rail 412. As shown in FIG. 8G, lower pivot hinge 612 extends upward from bottom stationary anchor 610. Likewise, lower pivot hinge 616 extends upward from lower fulcrum contact piece 614. Lower fulcrum contact piece 614 is slidable within slot 618.

Lower guide rail 412 has a cross section that is fabricated in the general shape of a “u” with flanges pointing inward toward the center and groove 618 running down the middle so lower pivot hinge 616 can run horizontally within the lower guide rail 412. Rollers 618A and 618B are attached to sliding door 116A via axes 312. Roller 618A includes center extension 311 that fits into groove 618 of lower guide rail 412. Rollers 618A and 618B are wider than the groove 618 and both ride on the top of lower guide rail 412. Preferably, rollers 618A and 618B are made from a heavy duty convex nylon. Rollers 618A and 618B are attached to sliding door 416A in such a way as to enable sliding door 416A to be slid horizontally left or right while keeping sliding door 416A square in the closure. Center extension 311 holds sliding door 416A parallel to upper support track 410 and lower guide rail 412 while sliding door 416A is being slid leftward or rightward.

As in the example of FIGS. 1A-3H, as shown in FIGS. 8G and 8H, a fulcrum 611 may be provided that is rigidly connected to stationary bottom anchor 610 so as to stop lower fulcrum contact piece 614 just before stationary door magnet 512 and sliding door magnet 518 (FIG. 8F) are drawn together via magnetic force. Fulcrum 611 is installed in such a way as to work in unison with stationary door magnet 512 and sliding door magnet 518 and lower fulcrum contact piece 614 to tilt sliding door 416A so as to lift center extension 311 clear of groove 618 of lower guide track 412 (see also FIG. 8H).

In some implementations, a latch or other locking mechanism may be provided on the sliding doors to prevent the sliding door from being able to pivot about its axis, including when the sliding door is brought into contact with a neighboring magnet and lower fulcrum contact piece. In such implementations, the latch may allow a user more control over when the sliding door is allowed to pivot into an open position. For instance, as shown in the example of FIG. 81, a spring loaded door latch 473 is provided at the top right corner of the sliding door 416A. In other instances, a latch or other lock may be provided at the bottom corner of the sliding door in addition to or as an alternative to a latch at the top corner of the door. In this example, by pulling downward on the spring loaded door latch 473, a user causes the latch 473 to clear from slot 555 (FIG. 8F) and allows the user to swing door 416A open.

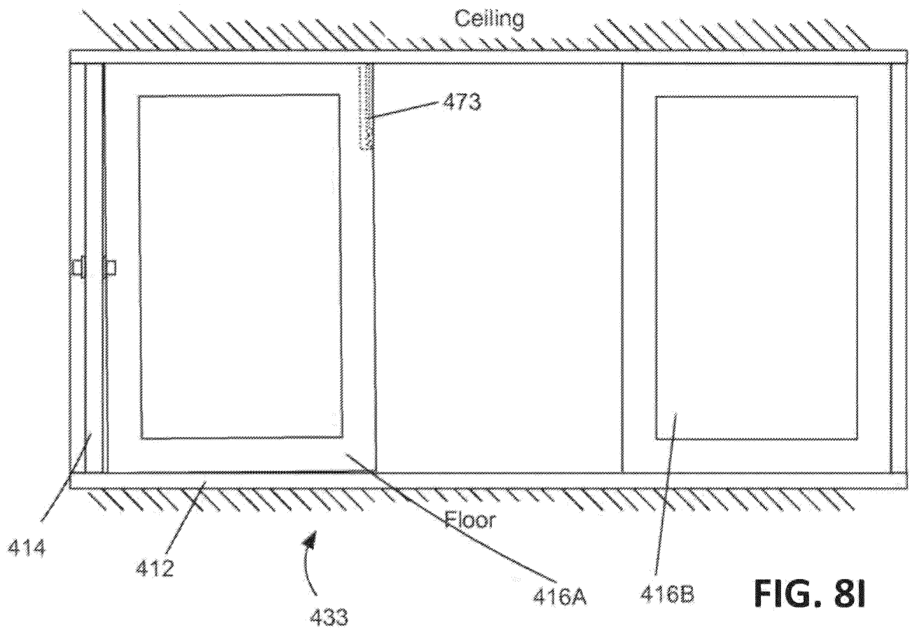

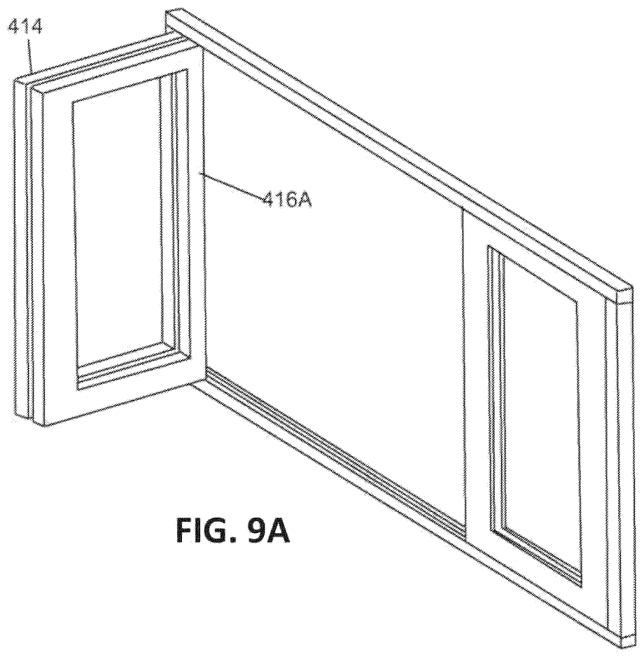

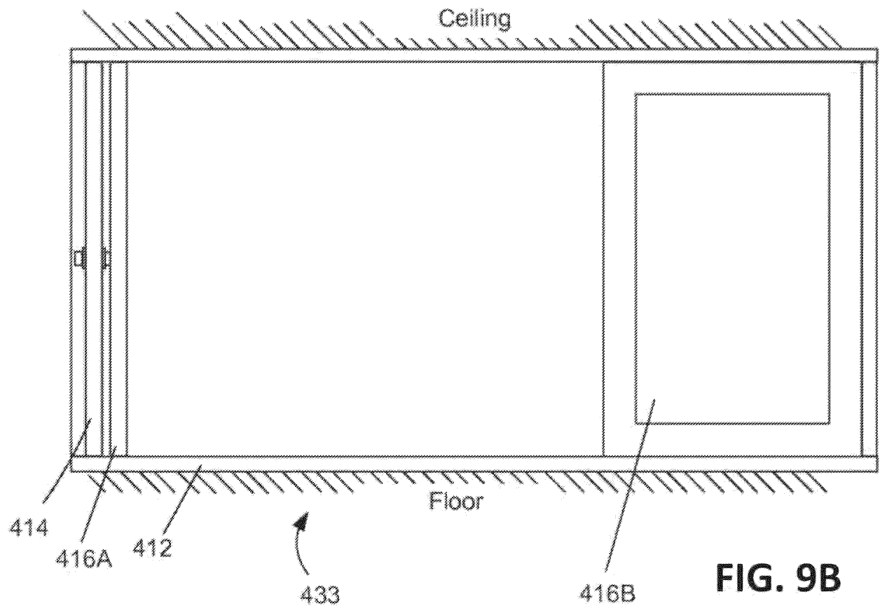

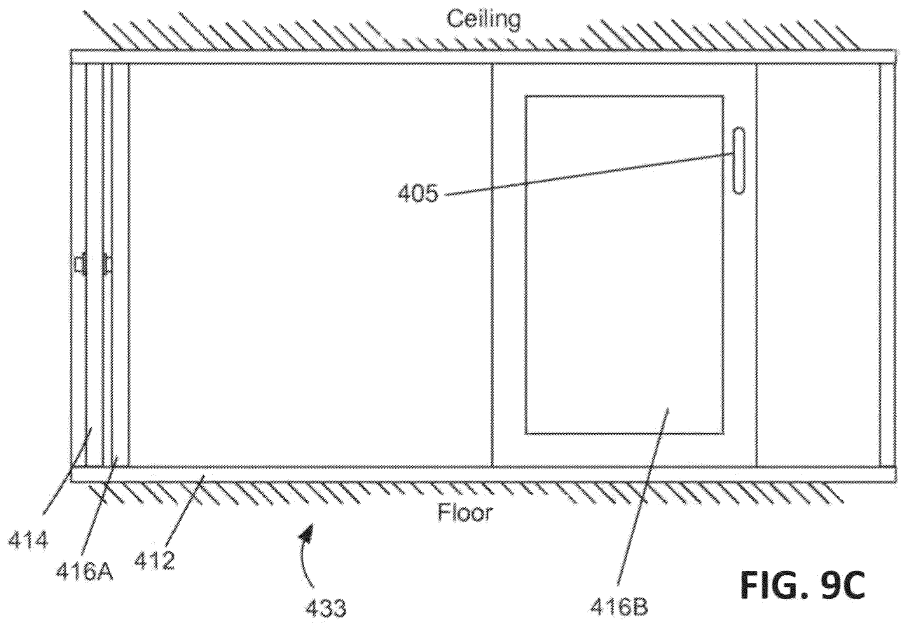

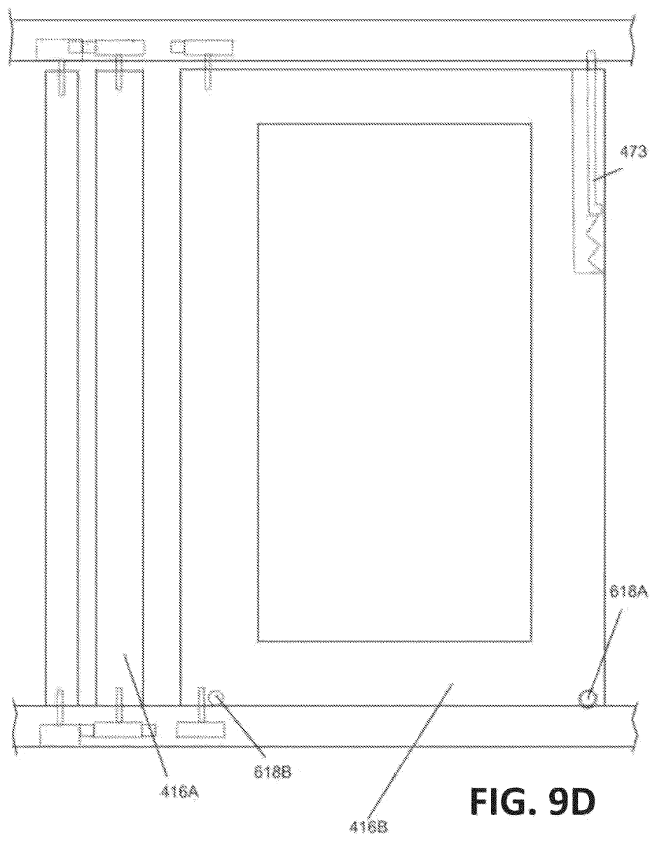

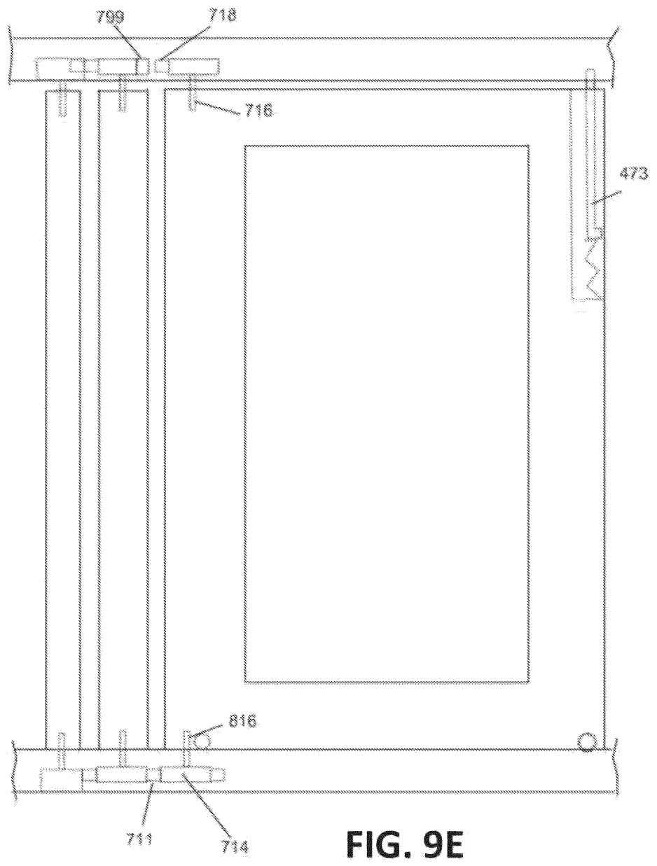

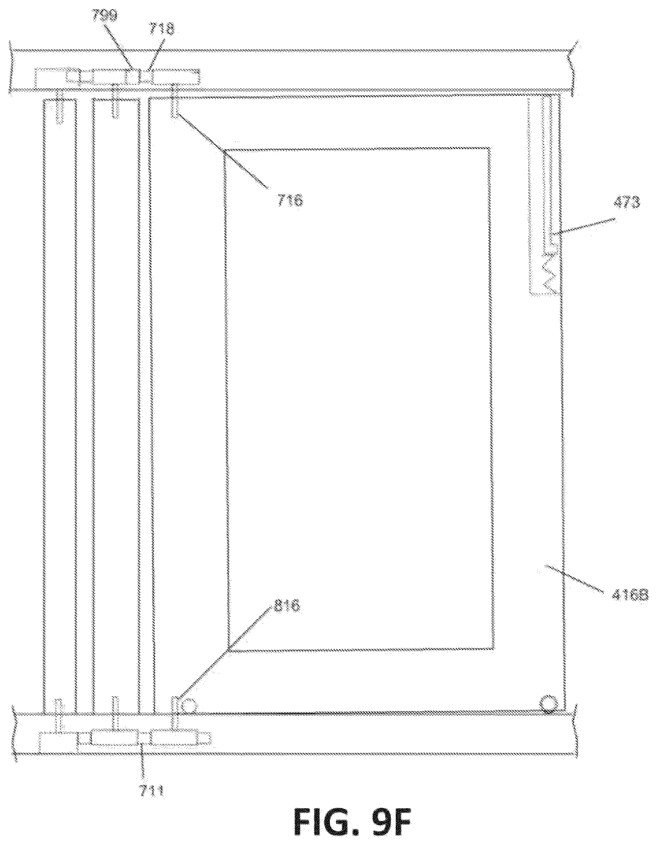

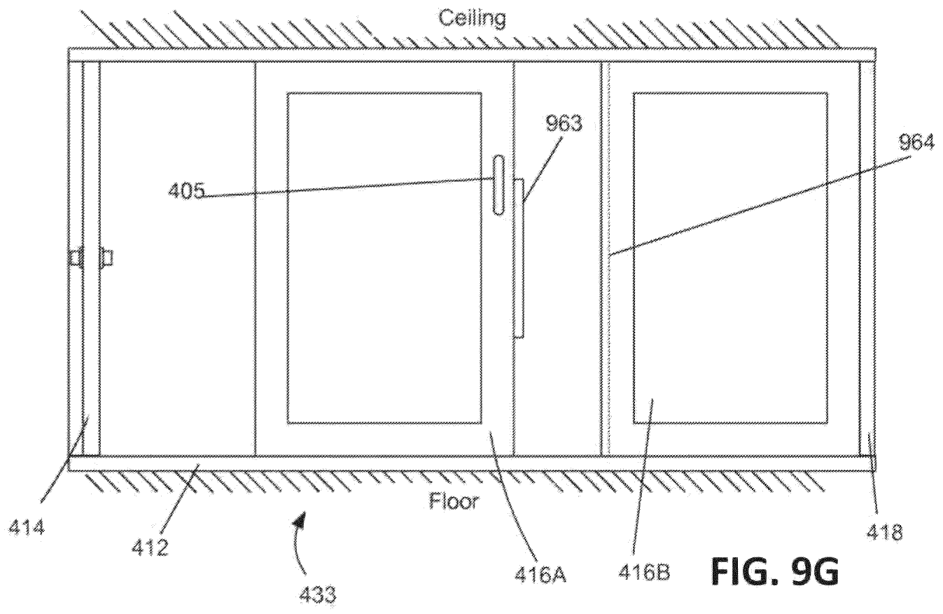

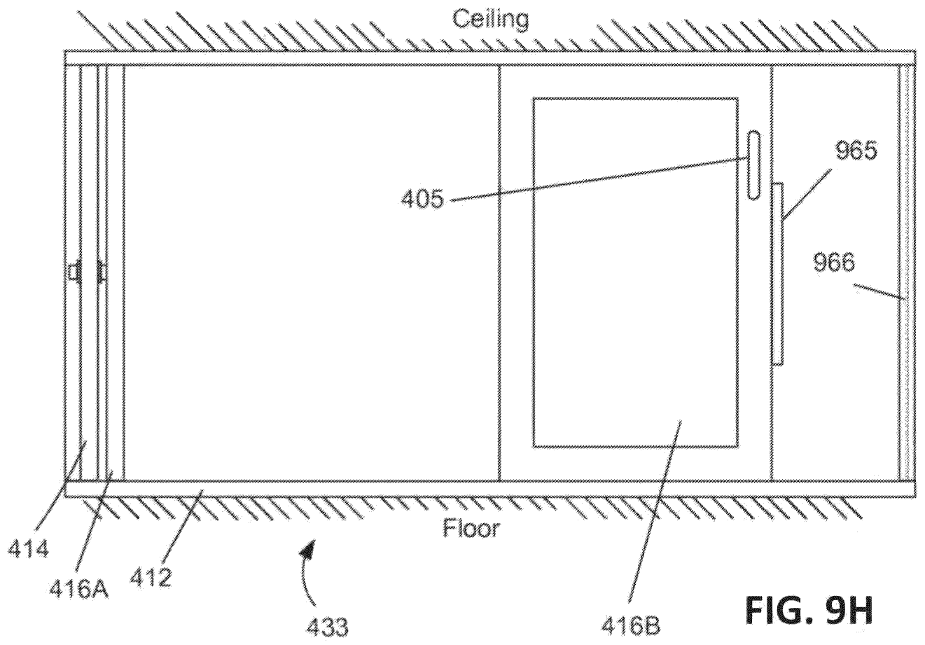

As shown in FIGS. 9A and 9B, because extension 311 is clear of groove 618 (FIGS. 8G and 8H) and latch 473 is clear from slot 555, the user is able to pull on sliding door 416A causing it to pivot about the axis formed by upper pivot hinge 516 (FIG. 8F) and lower pivot hinge 616 (FIG. 8G). In FIG. 9C the user has grabbed handle 405 of sliding door 416B and has pulled door 405 to the left. In FIG. 9D, the user has pulled sliding door 416B so that it is very close to opened sliding door 416A. Extension 311 is inside groove 618 (FIG. 8G) of lower guide track 412. Latch 473 is riding in slot 555.

In FIG. 9E, lower fulcrum contact piece 714 has made contact with fulcrum 711 by virtue of the sliding door 416B being slid over and into proximity of the opened stationary door 414 and opened sliding door 416A. Inside upper support track 410 magnet 718 has not made contact with magnet 799. However, the magnets are of sufficient strength and distance so that a magnetic force is drawing them together. In FIG. 9F, by bringing the sliding door 416B into closer proximity of opened sliding door 416B, the magnetic force has drawn magnet 718 and magnet 799 together. Fulcrum 711 has thereby caused sliding door 416B to pivot as shown so that extension 311 has cleared groove 618 (FIG. 8G) of lower track guide 412. A user may then disengage a lock or latch (e.g., by pulling downward on spring loaded door latch 473) to clear latch 473 from slot 555 (FIG. 8F) and allow the user to easily open sliding door 416B so that it can pivot about the axis formed by upper pivot hinge 716 and lower pivot hinge 816, as shown in FIGS. 9G and 9H.

### Tongue and Groove Door Connection

In some implementations, a press-fit tongue and groove connection may be implemented between neighboring sliding doors in a sliding door structure. The press-fit and tongue and groove connection may be provided in addition to or as an alternative to magnet-based connection implementations, such as shown and described in the example of FIG. 2C. For instance, as shown in the example of FIG. 9G, a press-fit tongue and groove connection is provided between sliding doors 416A and 416B and also between sliding door 416B and door jamb 418. As shown in FIG. 9G, tongue 963 is press-fit into groove 964. In FIG. 9H, tongue 965 press-fits into groove 966. For example, to slide doors 416A and 416B horizontally the user will grab handle 405 and pull to overcome the friction force between the tongue and groove connections and release sliding door 416A from its connection to sliding door 416B. In some implementations, the friction force is preferably greater between door 416B and door jamb 418, than it is between doors 416A and 416B, for instance, to allow door 416A to be released from door 416B, without also releasing door 416B from its connection to the door jamb 418 until the user independently pulls door 416B, among other examples. Indeed, in cases where a series of sliding doors are provided, the friction force provided at each tongue and groove connection from the sliding door nearest the stationary door to the final sliding door adjacent the opposite door jamb may increase in friction, among other example features and implementations.

### Reinforced Door Structure

While the sliding door structure implementations discussed above provide flexible utility in home and building design, the slideable and pivotable nature of the sliding doors within the sliding door structure may leave the overall sliding door structure more vulnerable to wind forces and rain forces than traditional door systems. For instance, providing sliding doors that can both slide and pivot may make the joints between neighboring sliding doors more vulnerable to wind and/or rain breaching the seals between adjoining door segments, thereby compromising the integrity of the sliding door structure. However, some locations, where flexible outdoor living spaces may be desirable and a sliding door structure may be used to facilitate such flexible outdoor living spaces (e.g., in coastal regions), may also be prone to extreme weather conditions (e.g., tropical storms, hurricanes, tornadoes, etc.). Further, building codes in such regions may require levels of structural reinforcement, which may be difficult to implement given that the sliding door structure is configured to move in multiple dimensions (e.g., slide back and forth and pivot open and closed, etc.).

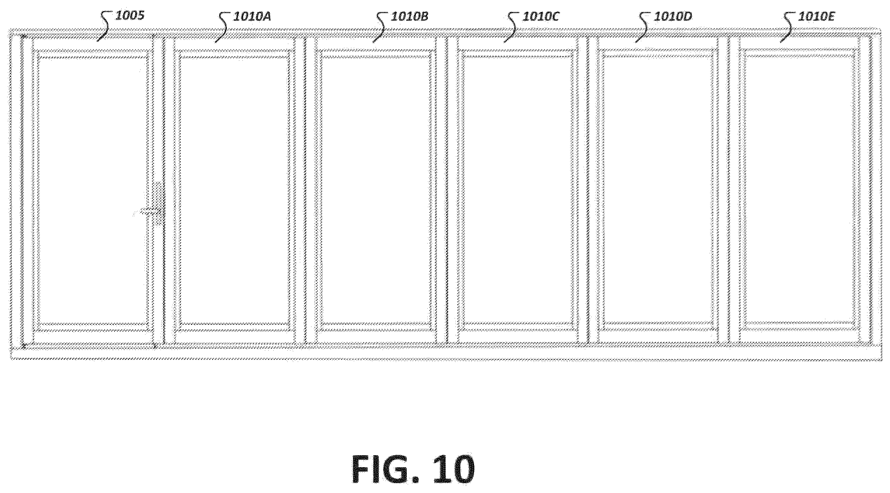

In some implementations, a reinforced sliding door structure may be utilized, for instance, in regions where extreme weather is a risk and/or local building codes require a higher structure rating, among other example considerations. For instance, FIG. 10 shows an example 6-door (or 6-panel) implementation of a sliding door structure configured, as the preceding embodiments are, to enable panels to slide and pivot to enable the sliding door structure to be opened with the panels stacked to one or both ends, or jambs, of the sliding door opening. For instance, the sliding door structure in the example of FIG. 10 may include a stationary door 1005 and five sliding doors 1010A-1010E. Each of the sliding doors may be capable of sliding and pivoting such as in the above described and illustrated examples of sliding door panels. Other implementations may include more or fewer sliding doors. In some implementations, each sliding door panel (e.g., 1010A-1010E) may include one or more tongue and/or groove elements to enable the respective tongue and groove elements of neighboring door panels to interlock and releasably seal the joint between the door panels, similar to the tongue and groove elements introduced in the examples of FIGS. 9G-9H. To facilitate a stronger coupling between the sliding door panels and minimize the passage of air and/or water between the panels, the tongue and/or groove elements may run all or substantially most of the height of the side of each door.

More particularly, in the example of FIG. 10, no tongue or groove member is provided on the left side of the first sliding door 1010A, in order to allow the stationary door 1005 to pivot and open freely. A tongue and groove connector (with a tongue on one of the first sliding door 1010A or the second sliding door 1010B and a complimentary groove on the other of the second sliding door 1010B or the first sliding door 1010A) is used to couple the first sliding door 1010A and the second sliding door 1010B. Likewise, press-fit tongue and groove connectors are provided to couple the second sliding door 1010B and the third sliding door 1010C, the third sliding door 1010C and the fourth sliding door 1010D, and the fourth sliding door 1010D and the fifth sliding door 1010E. The fifth sliding door 1010E includes a tongue or groove to couple to a complimentary groove or tongue at door jamb 1015. Accordingly, while the first sliding door 1010A only includes a tongue and groove connector at its right side, the remaining sliding door panels may include tongue and groove connectors at each of their right and left sides.

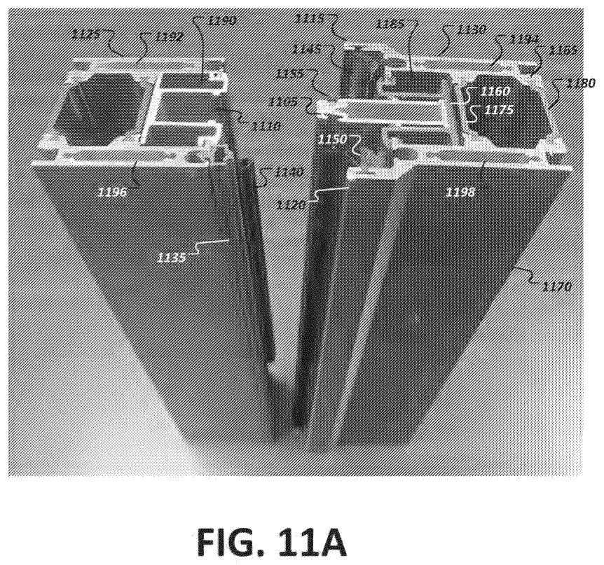

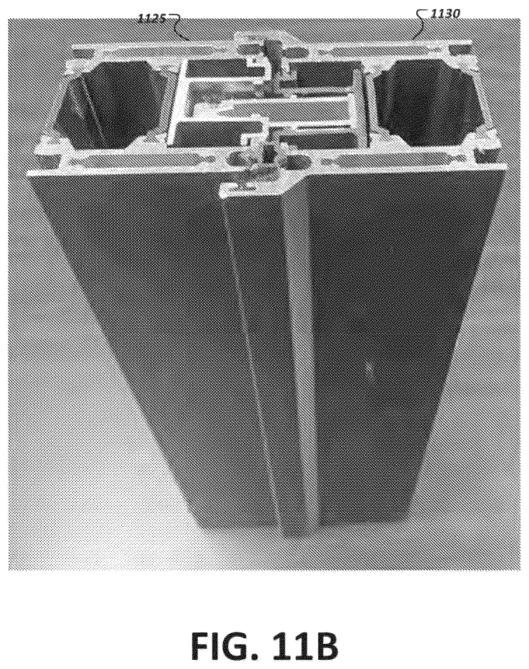

FIGS. 11A-11B show close-up views of example mating tongue (e.g., 1105) and groove (e.g., 1110) elements that may be included on the edges of sliding doors within an example sliding door structure. To enhance the structural stability of the sliding door structure, the tongue and groove elements may run the entire length of the door. In some instances, clearances, or “cut outs”, may be provided at the top and/or bottom of the door, such that tongue elements clear the upper and/or bottom support tracks.

As shown in the examples of FIGS. 11A-11B, in some implementations, the edges of the sliding doors may include flange or overlap members (e.g., 1115, 1120) to further reinforce the joint between neighboring door panels. When a sliding door is connected to a neighboring door (or door jamb) using a press-fit tongue and groove connector, the flange may cover the joint between the sliding doors to block ingress of wind or moisture. Such flanges may be included at the outer side of the sliding doors, the inner side of the sliding door, or both the inner and outer sides (such as in the example of FIGS. 11A-11B).

FIGS. 11A-11B are cross-sectional perspective views of a right-most door panel frame or edge member 1125 of a first sliding door panel and a left-most door panel frame or edge member 1130 of a second neighboring sliding door panel for inclusion in a sliding door structure assembly. One of the door panel frame members (e.g., 1125) may have a groove, or female, channel element (e.g., 1110), which is configured to mate with or accept a tongue, or male, rail element (e.g., 1105), when the neighboring doors are slid into a connected closed position. The tongue rail may run the length of the door panel frame, only interrupted to allow for handles, throw bolt latches, or other elements of the door so as to maximize the structural support facilitated through the tongue element. The tongue element may be constructed of extruded aluminum, steel, or another rigid material capable of imparting structural stability to the joint formed by the panel frame members 1125, 1130 when they are brought into a connected position. The groove or channel element (e.g., 1130) may be constructed of similarly rigid and structurally strong material (e.g., a metal or a non-conductive rigid material).

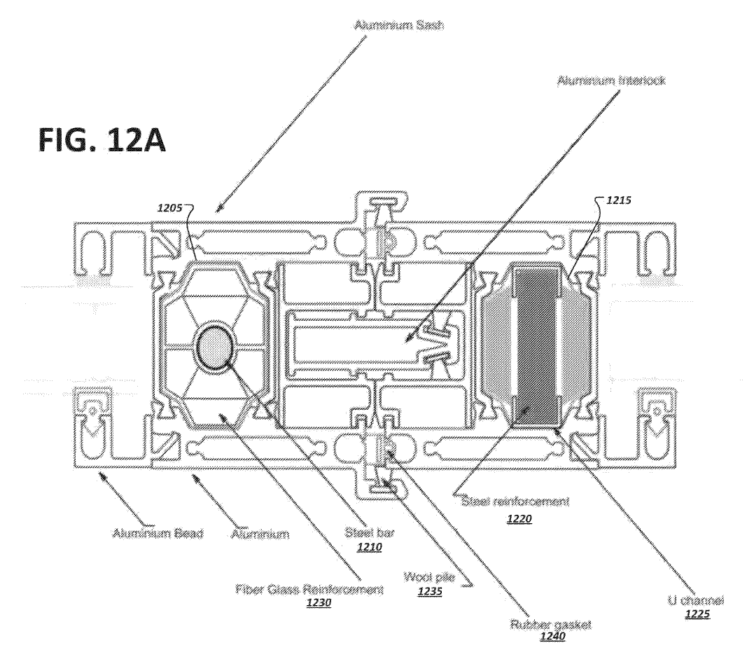

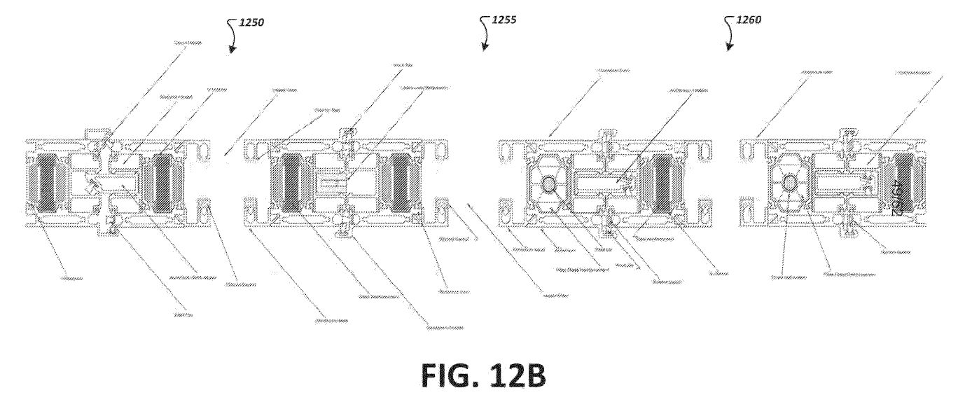

As shown in FIG. 11B, when neighboring door panel frame members are connected through the tongue-and-groove mating of elements 1105 and 1110, the flange elements 1115, 1120 of the second door panel frame overlap the edges of the first door panel frame and effectively cover the joint between the two door panels and further seal this joint against weather conditions. The door panel frame elements may be provided with weather stripping to further seal gaps in the joint, such as wool pile strips, rubber gasket strips, among other examples, including those illustrated in FIGS. 11A-12B. For instance, a rubber gasket strip or other weather stripping (e.g., 1135) may be provided at the front edge (and rear edge 1140) of the panel frame member 1125. Wool pile strips, mohair strip, or other weather stripping (e.g., 1145, 1150) may be provided on the inner sides of the flanges 1115, 1120 to improve the seal between the neighboring sliding door panels and/or to configure the amount of friction provided at the press-fit tongue and groove connector. In some cases, weather stripping or other material (e.g., 1155) may be provided in the channel element 1110 and/or tongue element 1105, among other examples.

While providing metal tongue and groove elements in interlocking sliding door panel frame segments may serve to structurally reinforce and increase the weather rating of a sliding door system, the provision of additional heat conductive metal elements (e.g., metallic tongue element 1105 and metallic channel or groove element 1110) within a sliding door panel may compromise its energy efficiency. Accordingly, as shown in the examples of FIGS. 11A-12B, hollow channels and cavities (e.g., 1192, 1194, 1196, 1198, etc.) may be provided opportunistically within the body of the panel frame to provide insulation (e.g., insulative air pockets). In some cases, these hollow cavities may be filled with an insulative material to enhance the insulation and seal the hollows. Further, as shown for instance in FIGS. 11A-11B, the metallic tongue and groove members may be assembled within respective cartridge elements made of a plastic or another rigid insulative or non-conductivematerial, such that the conduction of heat from the outside surface of the panel frame to the opposing interior surface of the door panel frame is interrupted and mitigated by the plastic cartridge elements. The metallic tongue 1105 may be inserted within the cartridge 1160 before being inserted between inner sash segment 1165 and outer sash segment 1170. Likewise, a metallic groove segment may be inserted in a corresponding non-metallic cartridge element in some implementations (e.g., to implement a respective thermal break), among other example implementations and features.

In one example, the left, right, upper, or lower sash of a sliding door may be constructed by attaching a respective inner sash segment 1165 to an outer sash segment 1170 using two thermal break elements 1175, 1180 (e.g., made of a plastic (e.g., polyamide)) which run the length of the sash. For instance, the thermal break elements 1175, 1180 may be pinched or crimped to permanently connect to each one of the sash segments (e.g., 1165, 1170). With the inner and outer sash segments coupled via thermal break elements 1175, 1180, a sash section is formed. A tongue element 1105 inserted in a cartridge 1160 may then be slid into an opening (e.g., 1185) within the sash segment and attached within the sash segment by a fastener (e.g., a screw, a weld, through an adhesive, etc.). Similarly, the groove element may be slid into and fastened within an opening (e.g., 1190) in a sash segment corresponding to a groove-side of the press-fit tongue and groove connector, among other examples.

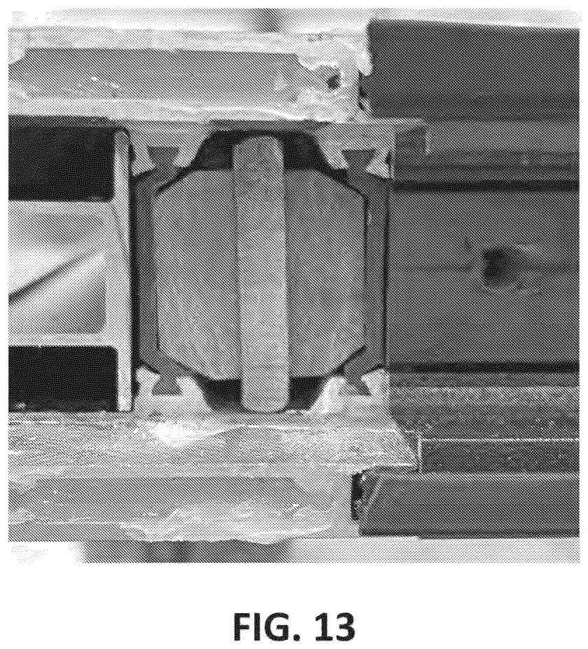

FIG. 12A is a cross-sectional diagram illustrating two door panel frame segments 1125, 1130 interlocked by a pairing of reinforced tongue 1105 and groove 1110 elements. FIG. 12A further shows the provision of various wool pile and rubber gasket weather stripping elements (e.g., 1235, 1240, etc.), which may be inserted within corresponding grooves fashioned within extruded aluminum panel frame elements, among other examples. FIG. 12A further shows the provision of additional reinforcement mechanisms, which may be provided within a reinforced sliding door structure. For instance, a channel 1205 provided on a door panel frame element having the tongue element and flange elements may be provided with shoot bolts, or throw bolts, (e.g., 1210), which may be engaged to lock the sliding door panel frame at the upper and lower tracks to provide further structural stability to the sliding door structure (e.g., in the event of a storm). The channel 1205 may be filled with and reinforced with solid fiber glass or other insulative materials 1230 around the metal (e.g., steel) throwbolt(s). In the panel frame of the neighboring door panel (e.g., behind the corresponding groove element), a similar channel or opening 1215 may be provided within the door panel frame. In one example, a steel reinforcement beam 1220 may be provided within the opening and run substantially the length of the door panel frame element to reinforce this door panel frame element as well. Insulative material may fill any remaining gaps within the channel 1215 around the beam 1220 and provide additional structure stability without adding to the conductivity of the door panel frame element, among other example features and enhancements. Further, thermal break padding (e.g., 1225) may be provided, in some implementations, to mitigate the conduction of thermal energy through the beam 1220, among other example features. FIG. 13 is a photograph showing a cross-sectional view of an example channel with a steel beam 1120 provided within the opening and sandwiched by solid insulative materials 1305, 1310 and plastic cross-members 1315, 1320. FIG. 12B presents an expanded view of a multi-panel reinforced sliding door system, including a stationary door 1250 and sliding door panels 1255, 1260 each equipped with respective tongue and groove panel frame elements and throw bolt locking elements.

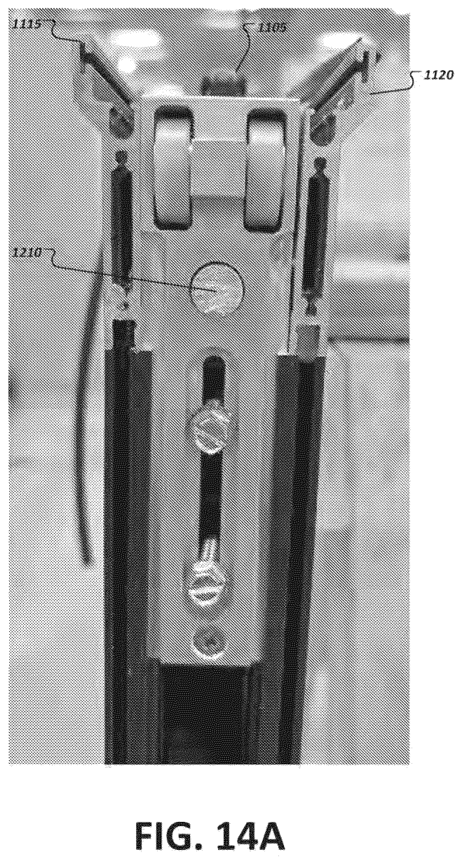

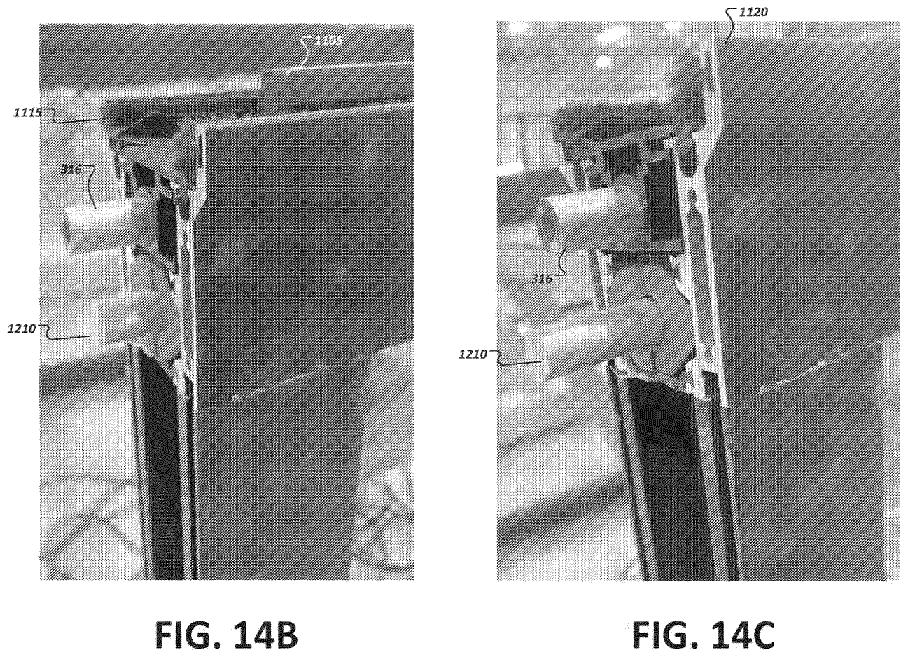

FIGS. 14A-14C show views of an example shoot bolt, or throwbolt, mechanism provided within a door panel frame element of an example reinforced door panel (e.g., using overlap flange elements (e.g., 1115, 1120) and reinforced tongue and groove (e.g., 1105) door panel frame elements). FIG. 14A shows a view of the bottom of a door panel, including bogie wheels and throwbolt element 1210. FIGS. 14B-14C show another view of the bottom of an example reinforced door panel, with the pivot hinge (e.g., 316) exposed, as well as the lower throwbolt 1210. FIG. 14B shows the throwbolt 1210 in a recessed or disengaged position, while FIG. 14C shows the throwbolt 1210 in an extended or engaged position. In some implementations, a door panel may include both the throwbolt (to lock sliding door panels for additional stability) in addition to a door latch that is utilized, when the sliding door is tilted by the fulcrum, to enable the sliding door to pivot into an opened position. Separate handles or hooks may be provided on the side of a door panel frame for engaging/disengaging the door latch and for engaging/disengaging upper and/or lowerthrowbolts. In such implementations, the door latch may be considered the primary mechanism for allowing the sliding door to pivot open during use, while the throwbolts are intended for use when the sliding door panels are in their closed position are to be locked into place (e.g., for security or in anticipation of a weather event), among other example implementations.

Although the above-preferred embodiments have been described with specificity, persons skilled in this art will recognize that many changes to the specific embodiments disclosed above could be made vvithout departing from the spirit of the disclosure. Indeed, elements of the various embodiments discussed above may be combined to implement additional embodiments beyond those explicitly illustrated and such additional embodiments are within the scope of the present disclosure. For example, although the above preferred ernbodirnents specifically disclose the utilization of magnetic force to attract the upper bogie to the upper anchor, it should be understood that a variety of other mutual attraction devices could also be utilized. For example, some of these include a rotating cam, a plethora of gears, a winged apparatus, a hook and latching pin, and a hollow cam and a solid cam that pivot and interlock. Also, although the above described preferred embodiments disclosed extension 11 attached to roller 318, it is possible to utilize other extension types. For example, any extension shape will vvork so long as it is able to clear groove 13 when the sliding door is tilted by the fulcrum. Also, although it was shown that upper bogie 214 and lower bogie 314 utilized wheels 9 for rolling, it is possible to omit the wheels and utilize bogies that slide within the upper support track and lower guide rail.

Therefore, the attached claims and their legal equivalents should determine the scope of the disclosure.

The following examples pertain to embodiments in accordance with this Specification. Example 1 is a sliding panel structure, including: a frame including an upper support track and a lower guide rail; a first panel connected between the upper support track and the lower guide rail, where a vertical edge of the first panel includes a groove member; a second panel connected between the upper support track and the lower guide rail, where the second panel includes a sliding panel and includes: a tongue member configured to mate with the groove member of the first panel, where the tongue member is disposed on a first vertical edge of the second panel; one or more flange elements disposed on the first vertical edge to overlap a portion of the first panel when the tongue member is inserted into the groove member; a sliding panel pivot axis; and an extension for riding in the lower guide rail to prevent undesired pivoting of the second panel about the sliding panel pivot axis; and a first mutual attraction device, including: a first mutual attraction part; and a second mutual attraction part connected to the second panel; and a fulcrum for tilting the second panel when the first mutual attraction part engages the second mutual attraction part, the tilting of the second panel allowing for the extension to disengage the lower guide rail to allow the second sliding panel to pivot about the sliding panel pivot axis.

Example 2 includes the subject matter of example 1, further including a throwbolt provided within a cavity of a panel frame of the second panel parallel with the first vertical edge, where the throwbolt, when engaged, locks the second panel to prevent the second panel from pivoting.

Example 3 includes the subject matter of any one of examples 1-2, where the flange elements reinforce a joint between the first and second panels against inclement weather. Example 4 includes the subject matter of example 3, where the second panel further includes a latch to enable pivoting of the second panel about the sliding panel pivot axis when the second panel is tilted by the fulcrum.

Example 5 includes the subject matter of any one of examples 1-4, where the first panel includes a non-sliding panel.

Example 6 includes the subject matter of example 5, where the non-sliding panel is configured to swing open about an axis.

Example 7 includes the subject matter of any one of examples 5-6, where the first panel includes a flange element to overlap a portion of the second panel when the tongue member is inserted into the groove member.

Example 8 includes the subject matter of any one of examples 1-7, further including one or more additional sliding panels.

Example 9 includes the subject matter of example 8, where the second panel includes a second vertical edge including a groove element and the groove element is to mate with a tongue element on a vertical edge on a neighboring one of the one or more additional sliding panels.

Example 10 includes the subject matter of example 9, where a second panel frame of the second panel corresponds to the second vertical edge, the second panel frame includes a cavity and a metal reinforcement member within the cavity.

Example 11 includes the subject matter of any one of examples 1-10, where the frame includes a door frame and the first and second panels include respective door panels.

Example 12 includes the subject matter of any one of examples 1-10, where the frame includes a window frame and the first and second panels include respective window panels.

Example 13 includes the subject matter of any one of examples 1-12, where the second panel includes a non-metallic cartridge and the tongue member is mounted in the cartridge, and the tongue member is coupled to the second panel using the cartridge.

Example 14 includes the subject matter of example 13, where the cartridge implements a thermal break within the second panel.

Example 15 is a method to assemble the second panel of any one of examples

Example 16 is a method to assemble the sliding panel structure of any one of examples 1-14.

Thus, particular embodiments of the subject matter have been described. Other embodiments are within the scope of the following claims. In some cases, the features, components, and actions recited in the claims can be arranged or performed in a different manner and still achieve desirable results. In addition, the processes depicted in the accompanying figures do not necessarily require the particular order shown, or sequential order, to achieve desirable results.

A detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. A sliding panel structure, comprising:
a frame comprising an upper support track and a lower guide rail;
a first panel connected between the upper support track and the lower guide rail, wherein a vertical edge of the first panel comprises a groove member;
a second panel connected between the upper support track and the lower guide rail, wherein the second panel comprises a sliding panel and comprises:
a tongue member configured to mate with the groove member of the first panel, wherein the tongue member is disposed on a first vertical edge of the second panel;
one or more flange elements disposed on the first vertical edge to overlap a portion of the first panel when the tongue member is inserted into the groove member;
a sliding panel pivot axis; and
an extension for riding in the lower guide rail to prevent undesired pivoting of the second panel about the sliding panel pivot axis; and
a first mutual attraction device, comprising:
a first mutual attraction part; and
a second mutual attraction part connected to the second panel; and a fulcrum for tilting the second panel when the first mutual attraction part engages the second mutual attraction part, the tilting of the second panel allowing for the extension to disengage the lower guide rail to allow the second panel to pivot about the sliding panel pivot axis.

2. The sliding panel structure of claim 1, further comprising a throwbolt provided within a cavity of a panel frame of the second panel parallel with the first vertical edge, wherein the throwbolt, when engaged, locks the second panel to prevent the second panel from pivoting.

3. The sliding panel structure of claim 1, wherein the flange elements reinforce a joint between the first and second panels against inclement weather.

4. The sliding panel structure of claim 3, wherein the second panel further comprises a latch to enable pivoting of the second panel about the sliding panel pivot axis when the second panel is tilted by the fulcrum.

5. The sliding panel structure of claim 1, wherein the first panel comprises a non-sliding panel.

6. The sliding panel structure of claim 5, wherein the non-sliding panel is configured to swing open about an axis.

7. The sliding panel structure of claim 5, wherein the first panel comprises a flange element to overlap a portion of the second panel when the tongue member is inserted into the groove member.

8. The sliding panel structure of claim 1, further comprising one or more additional sliding panels.

9. The sliding panel structure of claim 8, wherein the second panel comprises a second vertical edge comprising a groove element and the groove element is to mate with a tongue element on a vertical edge on a neighboring one of the one or more additional sliding panels.

10. The sliding panel structure of claim 9, wherein a second panel frame of the second panel corresponds to the second vertical edge, the second panel frame comprises a cavity and a metal reinforcement member within the cavity.

11. The sliding panel structure of any claim 1, wherein the frame comprises a door frame and the first and second panels comprise respective door panels.

12. The sliding panel structure of claim 1, wherein the frame comprises a window frame and the first and second panels comprise respective window panels.

13. The sliding panel structure of claim 1, wherein the second panel comprises a non-metallic cartridge and the tongue member is mounted in the non-metallic cartridge, and the tongue member is coupled to the second panel using the cartridge.

14. The sliding panel structure of claim 13, wherein the cartridge implements a thermal break within the second panel.

15. A method to assemble the second panel of claim 1.

16. A method to assemble the sliding panel structure of claim 1.
